(19) United States
(12) Patent Application Publication
(10) Pub. No.: US 2012/0140147 A1
(43) Pub. Date: Jun. 7, 2012

(54) DISPLAY PANEL, DISPLAY SYSTEM, PORTABLE TERMINAL AND ELECTRONIC DEVICE

(76) Inventors: Eiji Satoh, Osaka-shi (JP); Yasushi Asaoka, Osaka-shi (JP); Sayuri Fujiwara, Osaka-shi (JP); Kazuhiro Deguchi, Osaka-shi (JP)

(21) Appl. No.: 13/389,944

(22) PCT Filed: May 25, 2010
(86) PCT No.: PCT/JP2010/058814

§ 371 Date: Feb. 10, 2012

(30) Foreign Application Priority Data
Oct. 9, 2009 (JP) 2009-235738

(51) Int. Cl. G02F 1/1335

(52) U.S. Cl. 349/62

(57) ABSTRACT

To provide a display panel that can achieve a transparent state having high panel transmittance and that can carry out a display in which a figure looks as if it has popped up in the air, a display panel disclosed includes a PDLC panel (10) including: a substrate (20) including a wire; a substrate (30) provided so as to face the substrate (20); and a PDLC layer (40) provided between the substrate (20) and the substrate (30), the PDLC layer (40) including PDLC which is switched between a light transmitting state and a light scattering state in correspondence with the presence or absence of an electric field applied to the PDLC layer (40), the display panel including no colored layer, the display panel selectively forming a light transmitting region and a light scattering region in response to control of the presence or absence of the electric field applied to the PDLC layer (40), at least one of (i) a reflectance reducing layer for reducing direct reflection of external light by the wire, (ii) a light blocking layer covering the wire, and (iii) the PDLC layer (40) being placed in front of the wire as viewed from the observer.

### TECHNICAL FIELD

The present invention relates to a display panel, a display system, and an electronic device such as a portable terminal each of which can carry out a display with use of a light transmitting region and a light scattering region.

### BACKGROUND ART

Recent years have witnessed researches conducted on, for example, a display panel and an optical shutter each including, as a display medium, polymer dispersed liquid crystal (PDLC) or polymer network liquid crystal (PNLC).

A display panel including PDLC or PNLC, which display panel is switched between a light transmitting state and a light scattering state in response to an electric field applied thereto, has drawn attention in such fields as projector screens and digital signage.

Patent Literature 1 discloses a display system including, as a display panel, a transmittance control screen that includes PDLC and that can be switched as above between a transparent state and a non-transparent state partially. The display system displays a real image as blended in the background, and thus carries out a display of a real image that provides a sense of presence.

### Citation list

Patent Literature 1
Japanese Patent Application Publication, Tokukaihei, No. 5-191726 A (Publication Date: Jul. 30, 1993)

### SUMMARY OF INVENTION

### Technical Problem

Patent Literature 1 discloses that in Magic Vision (product name), in which an image projected on a screen by a projector located on an observer side is reflected by a half mirror so that the image is observed in the background as a virtual image, a displayed two-dimensional image can be observed three-dimensionally.

However, in the case where, as disclosed in Patent Literature 1, a projector located on the observer side simply projects a video image, without use of a half mirror, on a transmittance control screen including PDLC so that the image is blended in the background, it is impossible to (i) carry out a display in which the image looks as if it has popped up in the air from the display screen, and thus to (ii) observe a two-dimensional image three-dimensionally.

Further, a display panel including PDLC or PNLC, in the case where it includes a color filter to carry out a color display, problematically has a dark transparent region (non-display region).

In the case where PDLC is exposed to light from a color filter side, the exposure requires an extremely large illuminance.

A color filter, which reduces transmittance of visible light by a factor in the range of two to three, prevents a see-through display in which the a back surface side of the display panel is sufficiently seen through. A color filter also reduces transmittance of ultraviolet radiation necessary for polymerization of PDLC or PNLC by a factor of five or more, and thus requires use of an exposure device that can provide a large illuminance.

The present invention has been accomplished in view of the above problems. It is an object of the present invention to provide a display panel, a display system, and an electronic device such as a portable terminal each of which can (i) achieve a transparent state (see-through state) having high panel transmittance and (ii) carry out a display in which an image looks as if it has popped up in the air.

### Solution to Problem

In order to solve the above problem, a display panel of the present invention includes: a first substrate including a wire; a second substrate provided so as to face the first substrate; and a display medium provided between the first substrate and the second substrate, the display medium being switched between a light transmitting state and a light scattering state in correspondence with presence or absence of an electric field applied to the display medium, the display panel including no colored layer, the display panel selectively forming a light transmitting region and a light scattering region in response to control of the presence or absence of the electric field applied to the display medium, at least one of a reflectance reducing layer for reducing direct reflection of external light by the wire, a light blocking layer covering the wire, and the display medium being placed in front of the wire as viewed from an observer.

In order to solve the above problem, a display panel of the present invention includes: a first substrate including a wire; a second substrate provided so as to face the first substrate; and a display medium provided between the first substrate and the second substrate, the display medium being switched between a light transmitting state and a light scattering state in correspondence with presence or absence of an electric field applied to the display medium, the display panel including no colored layer, the display panel selectively forming a light transmitting region and a light scattering region in response to control of the presence or absence of the electric field applied to the display medium, an anti-reflection film being provided on a surface of at least one of the first substrate and the second substrate.

The above display panel includes no colored layer (color filter), and can thus achieve, in the light transmitting region, a transparent state (see-through state) having high panel transmittance. This makes it possible to carry out a display in which a display image looks as if it has popped up in the air from a surface of the display panel.

If, however, there is direct reflection by the wire, such direct reflection significantly ruins the expression that a display image looks as if it has popped up in the air.

In the case of carrying out a three-dimensional display in which a display image looks as if it has popped up in the air, it is ideal to display such a figure in an empty space. However, at least in the case where such a display is carried out above a substrate including glass or the like, external light becomes visible due to substrate surface reflection. If external light becomes visible in the light transmitting region (that is, a non-display section in which no image is displayed with use of light projected by the light source device), visibility of such external light significantly ruins the effect that causes the image displayed in the light scattering region to look as if it has popped up in the air.

Thus, if (i) no anti-reflection film is provided on a surface of at least one of the first substrate and the second substrate and (ii) the display panel is not provided, in front of the wire as viewed from the observer, with a member for preventing direct reflection by the wire, a display on the display panel will merely look like an image created on a glass surface.

However, in the case where there is provided, as described above, at least one of (1) at least one of the reflectance reducing layer, the light blocking layer, and the display medium, each of which is placed in front of the wire as viewed from the observer, and (2) an anti-reflection film provided on a surface of at least one of the first substrate and the second substrate, it is possible to carry out a unique and impactful display in which an image in the light scattering region looks as if it has popped up in the air.

The present invention, which includes the above constituent member (1), prevents direct reflection by the wire. Further, the present invention, which includes the above constituent member (2), prevents substrate surface reflection. Merely including at least one of the constituent members (1) and (2) makes it possible to, as described above, carry out a display in which an image in the light scattering region looks as if it has popped up in the air. However, including both the constituent members (1) and (2) achieves a more significant advantage due to a synergistic effect thereof.

The above constituent members consequently make it possible to provide a display system that can (i) achieve a transparent state (see-through state) having high panel transmittance and (ii) carry out a display in which a figure looks as if it has popped up in the air.

A display system of the present invention includes: a display device including the display panel of the present invention; and a light source device for projecting a monochrome or multicolor light beam onto the display panel.

The above arrangement, in which the display panel includes no colored layer, allows the light scattering region of the display panel to display light having any color and projected by the light source device.

The display panel, when carrying out a color display, can express colors with use of the light source device. This eliminates the need for the display panel to include a colored layer, and consequently improves the transmittance of the display panel.

Further, the display system, which includes the display panel of the present invention as described above, can eliminate (reduce) at least one of (i) influence of direct reflection of external light by the wire and (ii) influence of substrate surface reflection as described above.

The above arrangement consequently makes it possible to provide a display system that can (i) achieve a transparent state (see-through state) having high panel transmittance and (ii) carry out a display in which a figure looks as if it has popped up in the air.

An electronic device of the present invention includes: the display system of the present invention.

The electronic device can be any of various electronic devices, for example: an electronic device, such as a mobile telephone, an electronic dictionary, and an electronic picture frame, which can be used as a portable terminal; digital signage; a theater system; a display for office use; and a videoconference system.

A portable terminal of the present invention includes: the display system of the present invention.

The above arrangements, in which the electronic device and the portable terminal each include the display system of the present invention, can each (i) achieve a transparent state (see-through state) having high panel transmittance and (ii) carry out a display in which a figure looks as if it has popped up in the air.

### Advantageous Effects of Invention

The display panel, display system, portable terminal, and electronic device of the present invention each include (i) the display panel that includes no colored layer and that selectively forms a light transmitting region and a light scattering region in response to control of the presence or absence of the electric field applied to the display medium, and (ii) at least one of (1) at least one of the reflectance reducing layer, the light blocking layer, and the display medium, each of which is placed in front of the wire as viewed from the observer, and (2) an anti-reflection film provided on a surface of at least one of the first substrate and the second substrate. This arrangement makes it possible to carry out a unique and impactful display in which an image in the light scattering region looks as if it has popped up in the air.

### BRIEF DESCRIPTION OF DRAWINGS

FIG. 1 is an exploded perspective view schematically illustrating a configuration of a display system of an embodiment of the present invention, and schematically illustrates a display panel in an exploded view.

FIG. 2 is a plan view schematically illustrating a main portion of an active matrix substrate included in a display panel of an embodiment of the present invention.

FIG. 3 is a cross-sectional view, taken along line A-A of FIG. 2, schematically illustrating an example configuration of a display panel of an embodiment of the present invention.

FIG. 4 is a cross-sectional view, taken along line A-A of FIG. 2, schematically illustrating another example configuration of a display panel of an embodiment of the present invention.

FIG. 5 (a) and (b) are each a diagram illustrating an operating principle of a display system of an embodiment of the present invention.

FIG. 6 is a diagram illustrating an example image displayed on a display panel of an embodiment of the present invention.

FIG. 7 is a diagram illustrating an example display image in which a transparent portion is formed in a scattering portion of a display panel of an embodiment of the present invention.

FIG. 8 is a diagram illustrating an example display image in which a scattering portion is formed in a transparent portion of a display panel of an embodiment of the present invention.

FIG. 9 is a block diagram schematically illustrating an example configuration of a display system of an embodiment of the present invention.

FIG. 10 is a block diagram illustrating a circuit configuration of a video image control section of a display device in a display system of an embodiment of the present invention.

FIG. 11 is a diagram illustrating a makeup of a frame.

FIG. 12 is a diagram illustrating a pattern for manually aligning an image of a display panel with an image of a projector.

FIG. 13 is a block diagram schematically illustrating an example configuration of a display system of an embodiment of the present invention for a case in which alignment between an image of a display panel and an image of a projector is carried out automatically.

FIG. 14 is a perspective view schematically illustrating another example configuration of a display system of an embodiment of the present invention for a case in which alignment between an image of a display panel and an image of a projector is carried out automatically.

FIG. 15 is a perspective view schematically illustrating still another example configuration of a display system of an embodiment of the present invention for a case in which alignment between an image of a display panel and an image of a projector is carried out automatically.

FIG. 16 is a perspective view schematically illustrating yet another example configuration of a display system of an embodiment of the present invention for a case in which alignment between an image of a display panel and an image of a projector is carried out automatically.

FIG. 17 is a block diagram schematically illustrating another example configuration of a display system of an embodiment of the present invention.

FIG. 18 (a) is a graph illustrating a relation between a transmittance and an incidence angle of light for a case in which a display panel of an embodiment of the present invention has a refractive index of (i) 1 on its entrance side and (ii) 1.45 on its front surface, and (b) is a graph illustrating a relation between a transmittance and an incidence angle of light for a case in which a display panel of an embodiment of the present invention has a refractive index of (i) 1 on its entrance side and (ii) 1.65 on its front surface.

FIG. 19 is a cross-sectional view illustrating a direction in which liquid crystal droplets in a PDLC layer having a normal mode are arranged.

FIG. 20 is a cross-sectional view illustrating a direction in which liquid crystal droplets in a PDLC layer having a reverse mode are arranged.

FIG. 21 is an image illustrating a result of conducting a demonstrative experiment on an effect of the present invention.

FIG. 22 is another image illustrating a result of conducting a demonstrative experiment on an effect of the present invention.

FIG. 23 (a) is a cross-sectional view illustrating how a light-scattered display is carried out on a surface of a display system of an embodiment of the present invention for a case in which a light source device is provided with an ND filter, and (b) is a cross-sectional view illustrating how a light-scattered display is carried out on the surface of the display panel for a case in no ND filter is provided to the display system.

FIG. 24 is an elevational view schematically illustrating a configuration of a display system of an embodiment of the present invention, as viewed from a front surface side of a display panel, which display system includes a plurality of light source devices.

FIG. 25 is a bird's eye view illustrating a display device of an embodiment of the present invention which display device includes a plurality of display panels.

FIG. 26 is an elevational view schematically illustrating a configuration of an electronic picture frame including a display system of an embodiment of the present invention.

FIG. 27 (a) and (b) are each an elevational view schematically illustrating a configuration of a mobile telephone including a display system of an embodiment of the present invention.

FIG. 28 is a rear perspective view schematically illustrating the configuration of the mobile telephone illustrated in FIG. 27.

FIG. 29 is a cross-sectional view schematically illustrating the configuration of the mobile telephone illustrated in (a) and (b) of FIG. 27 and FIG. 28.

FIG. 30 is a diagram schematically illustrating an example electronic device including a display system of an embodiment of the present invention.

### DESCRIPTION OF EMBODIMENTS

The following description deals with embodiments of the present invention in detail.

### Embodiment 1

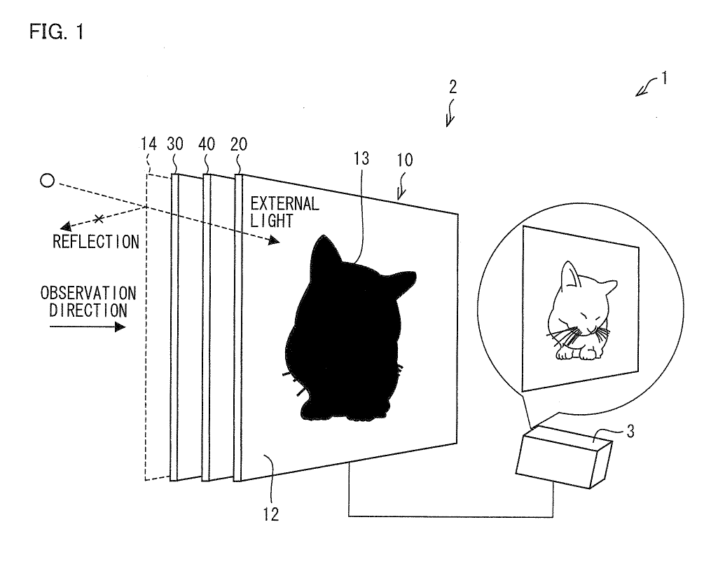

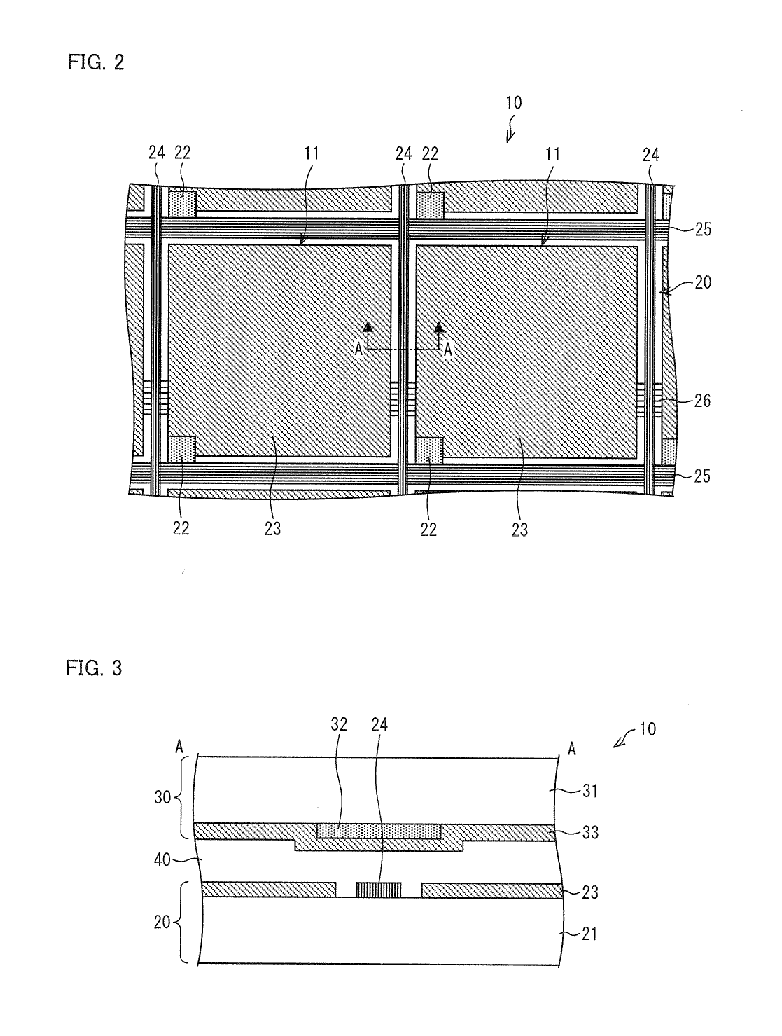

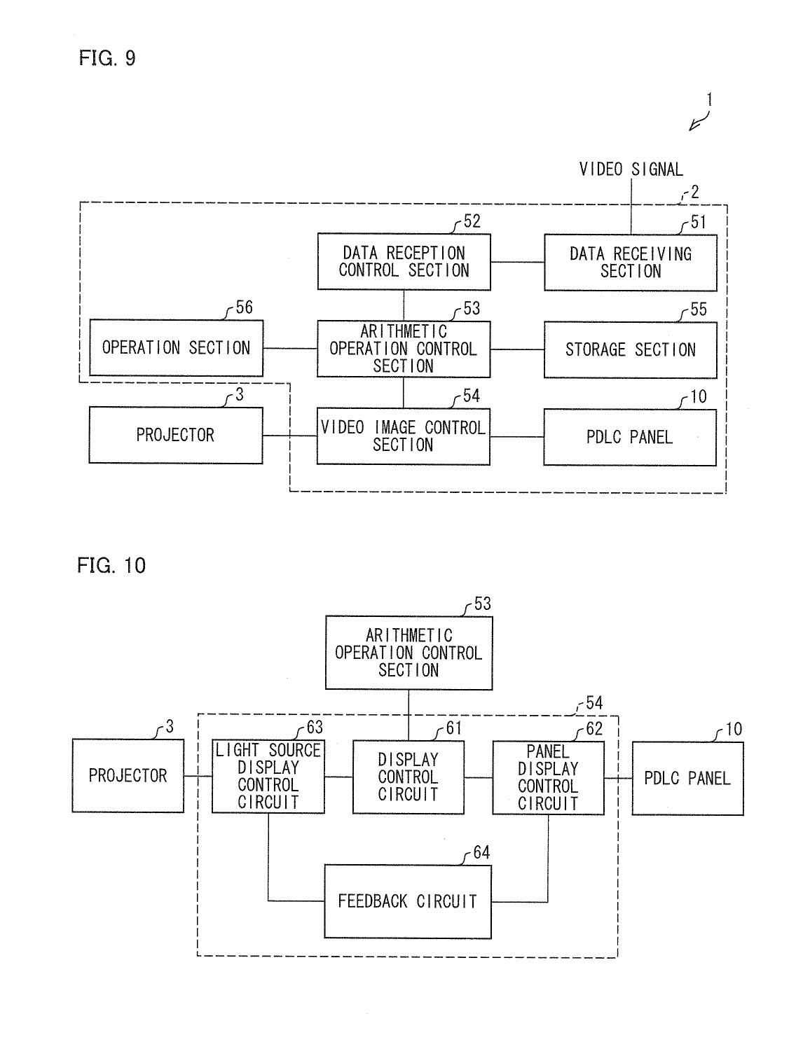

FIG. 1 is an exploded perspective view schematically illustrating a configuration of a display system of the present embodiment, and schematically illustrates a display panel in an exploded view. FIG. 2 is a plan view schematically illustrating a main portion of an active matrix substrate included in the display panel of the present embodiment. FIG. 3 is a cross-sectional view, taken along line A-A of FIG. 2, schematically illustrating an example configuration of the display panel of the present embodiment. FIG. 9 is a block diagram schematically illustrating an example configuration of the display system of the present embodiment.

The present embodiment mainly describes an example case in which the display system of the present embodiment includes a projector as a light source device (projector). The present embodiment is, however, not limited to such an arrangement. The light source device can be any of various light source devices that project monochrome or multicolor light. This light is not necessarily of a video image (image). In the description below, the word “projector” is replaceable with “projector.”

As illustrated in, for example, FIGS. 1 and 9, the display system 1 (liquid crystal display system) of the present embodiment includes: a display device 2 including a PDLC panel 10 (display section; display panel) that can be in a light scattering state or a light transmitting state; and a projector 3 that serves as a light source device and that emits light to the PDLC panel 10.

The following first schematically describes a configuration of the display device 2.

As illustrated in, for example, FIG. 9, the display device 2 includes, other than the PDLC panel 10 as a display panel, members each serving as a control section for controlling display by the PDLC panel 10 and its timing. Among such members are a data receiving section 51, a data reception control section 52, an arithmetic operation control section 53, a video image control section 54, a storage section 55, and an operation section 56. These members other than the PDLC panel 10 are described later in detail.

The PDLC panel 10 is, in the case where the projector 3 for displaying a video image (image) is used as a light source device, used as a screen for displaying a video image (colored image) projected by the projector 3.

The PDLC panel 10 is a liquid crystal panel that includes: a front substrate provided on an observer side; a back substrate provided on a side opposite to the observer side; and a PDLC (polymer dispersed liquid crystal) layer 40 that is sandwiched between the above two substrates and that serves as a display medium layer (light scattering layer; liquid crystal layer; light modulation layer).

The PDLC includes liquid crystal dispersed in a droplet form in a polymer. As its property, the PDLC switches between a light transmitting state and a light scattering state depending on whether or not an electric field is applied. With the PDLC panel 10 in a normal mode, the PDLC scatters light when no electric field is applied thereto, whereas the PDLC transmits light to be transparent when an electric field is applied thereto. With the PDLC panel 10 in a reverse mode, on the other hand, the PDLC transmits light when no electric field is applied thereto, whereas the PDLC scatters light to be non-transparent when an electric field is applied thereto. The above normal mode and reverse mode are described later in detail.

As described above, the PDLC panel 10 can switch between the light transmitting state and the light scattering state in correspondence with the magnitude of an electric field applied to the PDLC, specifically in correspondence with whether or not an electric field is applied to the PDLC.

The present embodiment carries out an active matrix drive with use of the above-described PDLC panel 10 to achieve a partial light scattering state.

Specifically, the PDLC panel 10 of the present embodiment is, as illustrated in FIG. 2, an active matrix liquid crystal panel that includes: a plurality of pixels 11 arranged in a matrix; and switching elements such as TFTs (thin film transistors) 22 provided for the respective pixels 11. The TFTs each control application of an electric field to the corresponding pixel 11 (for example, whether to apply an electric field thereto).

As illustrated in FIGS. 1 and 2, the PDLC panel 10 of the present embodiment includes: a substrate 20 (active matrix substrate; array substrate; first substrate) in which a large number of pixels 11 (see FIG. 2) are arranged in a matrix; a substrate 30 (counter substrate; second substrate) provided to face the substrate 20; and a PDLC layer 40 that is sandwiched between the above two substrates and that serves as a display medium layer (light scattering layer; liquid crystal layer) which can be in a light scattering state or a light transmitting state.

The description below deals with an example case in which, as illustrated in FIG. 1, (i) the substrate 30 as a counter substrate corresponds to the front substrate, and (ii) the substrate 20 as an active matrix substrate corresponds to the back substrate. The present embodiment is, however, not limited to such an arrangement.

The present embodiment describes an example involving, as the substrate 20 (active matrix substrate), a TFT (thin film transistor) substrate including TFTs as switching elements. The present embodiment is, however, not limited to such an arrangement.

The substrate 20 includes, as illustrated in FIG. 3, a transparent substrate 21, such as a glass substrate, which serves as an insulating substrate (display medium layer holding member; base substrate).

The transparent substrate 21 is provided thereon with a plurality of TFTs 22, pixel electrodes 23, and a plurality of wires such as source wires 24, gate wires 25, and Cs wires 26 (storage capacitor wires).

The TFTs 22 are identical in configuration to conventional ones. Further, other members such as a gate insulating film and an interlayer insulating film are well known. FIG. 3 thus omits the details of the TFTs 22 and members such as a gate insulating film and an interlayer insulating film.

The pixel electrodes 23 are transparent electrodes, and are made of a light-transmitting, electrically conductive material such as ITO (indium tin oxide). The pixel electrodes 23 are, as illustrated in FIG. 2, positioned away from one another, and each define a pixel 11 that serves as a unit of image display.

The TFTs 22 each have (i) a source electrode (not shown) connected to a source wire 24, (ii) a gate electrode (not shown) connected to a gate wire 25, and (iii) a drain electrode (not shown) connected to a pixel electrode 23. The source wire 24 is thus connected to the pixel electrode 23 via the TFT 22. The gate wire 25 causes the TFT 22 to operate selectively. A corresponding Cs wire 26 faces the pixel electrode 23 in such a manner as to form an auxiliary capacitor at a portion where the Cs wire 26 overlaps the pixel electrode 23.

The source wire 24 and gate wire 25, as illustrated in FIG. 2, cross each other as viewed in a direction normal to the substrate 30 (see FIG. 1), and are connected respectively to a source driver and gate driver of a driving circuit (not shown) included in the substrate 20.

The above source wire 24, gate wire 25, and Cs wire 26 are each normally made of a light-blocking metal material such as tantalum.

The substrate 30 includes, as illustrated in FIG. 3, a transparent substrate 31, such as a glass substrate, which serves as an insulating substrate (display medium layer holding member; base substrate).

The transparent substrate 31 is provided thereon with a black matrix 32 (light blocking film) and a counter electrode 33, which is a transparent conductive film made of, for example, ITO. The black matrix 32 is provided as necessary between adjacent pixels 11 and 11 and around a display region in such a pattern as to block light traveling toward (i) the wires such as the source wires 24, gate wires 25, and Cs wires 26 and (ii) the TFTs 22.

In the PDLC panel 10, controlling an electric field to be applied to the PDLC layer 40, that is, controlling a voltage to be applied between the counter electrode 33 and the pixel electrodes 23, allows the PDLC layer 40 to be switched between the light scattering state and the light transmitting state.

The PDLC panel 10 includes no CF (color filter; colored layer). Thus, controlling, with use of the TFTs 22, whether or not an electric field is applied to the PDLC enables selective formation of (i) a transparent portion 12, that is, a light transmitting region, and (ii) a scattering portion 13, that is, a light scattering region (see FIG. 1).

The display system 1 causes, for example, the projector 3 to project light (image) onto the PDLC panel 10 to display, in the scattering portion 13, the image projected by the projector 3. The display system 1 thus carries out a display in which a display image looks as if it has popped up in the air from a surface of the PDLC panel 10. If, however, the above wires directly reflect light, the expression of such a display image having popped up in the air will be ruined significantly.

Thus, in the PDLC panel 10, members such as the black matrix 32 (light blocking film) that, as described above, covers the wires and the PDLC layer 40 that serves as a light scattering layer are provided to be closer to the observer than the wires are (see FIGS. 1 and 3). This arrangement prevents external light from being directly reflected by the wires with respect to a main observation direction. This makes it possible to carry out a unique display in which a display image looks as if it has popped up from the surface of the PDLC panel 10.

The light blocking film and the PDLC layer 40 are not particularly limited in terms of thickness. The black matrix 32, in order to achieve an optical density (OD=2 to 4) necessary to block light traveling toward the TFTs 22, preferably has a thickness of, for example, (i) approximately 0.2 μm in the case where the black matrix 32 is made of chrome or (ii) approximately 1 to 2 μm in the case where the black matrix 32 is made of black resist. The PDLC layer 40 has a thickness that (i) preferably falls within the range of 3 μm to 20 μm in order to achieve transmittance (0.1% to 30%) for a light scattering state described below, or (ii) more preferably falls within the range of 3 μm to 15 μm in order to achieve both transmittance (40% to 90%) for a light transmitting state described below and transmittance (0.1% to 30%) for the light scattering state.

The above description deals with an example case in which, as illustrated in FIG. 3, (i) the black matrix 32 serving as a light blocking film is provided between the transparent substrate 31 and the counter electrode 33 and (ii) the substrate 30, which includes the black matrix 32, serves as the front substrate. Thus, in this example case, (i) the black matrix 32, (ii) the PDLC layer 40 (light scattering layer), and (iii) wires such as the source wires 24, the gate wires 25, and the Cs wires 26 are provided in that order as viewed from the observer. The present embodiment is, however, not limited to such an arrangement.

For example, in the case where the substrate 30, which is a counter substrate, serves as the front substrate as described above, a light blocking film such as a black matrix may be provided over the wires of the substrate 20 (that is, on a surface of the wires which surface faces the substrate 30).

In the case where a black matrix is to be provided in the substrate 20 as described above, a light blocking film can be provided over the wires by, for example, application of black resist over the wires, followed by exposure and development. The black resist in this case has a film thickness of, for example, 1 μm in order to achieve an optical density (OD=2 to 4) equivalent to that to be achieved in the case where a light blocking film is provided in the substrate 30.

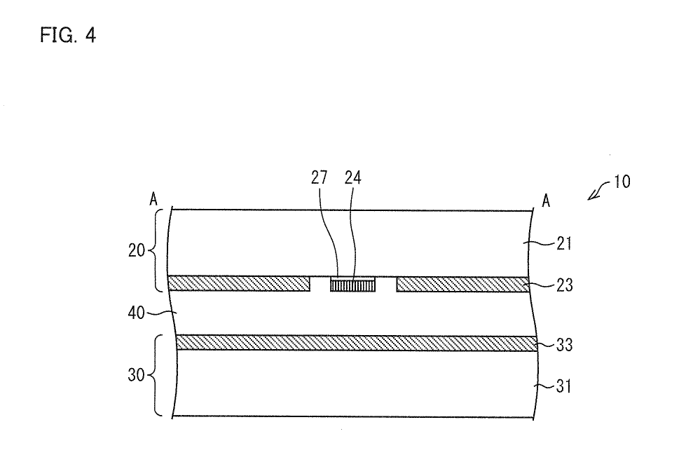

FIG. 4 is a cross-sectional view, taken along line A-A of FIG. 2, schematically illustrating another example configuration of the display panel of the present embodiment.

In the case where the substrate 20, which is an active matrix substrate (TFT substrate), serves as the front substrate, the substrate 20 may, as illustrated in FIG. 4, include a wire reflectance reducing layer 27 (reflectance reducing layer) such as a silicon nitride film and a thin metal film between the transparent substrate 21 and the above wires in the substrate (that is, on a back surface of the wires). The wire reflectance reducing layer 27 serves to reduce a light fraction which is reflected by the wires and which thus travels from a back surface of the substrate 20 serving as an active matrix substrate (the back surface being a surface opposite to a surface that faces the PDLC layer 40). FIG. 4 omits insulating films such as a gate insulating film and an interlayer insulating film.

The wire reflectance reducing layer 27 is not particularly limited in terms of thickness. The thickness may be set as appropriate in accordance with, for example, a material of the wire reflectance reducing layer 27, provided that the display panel can, as described above, carry out a display in which a display image looks as if it has popped up in the air from the surface of the PDLC panel 10.

The inventors of the present invention in their investigation (i) used the substrate 20 as a front substrate as described above, (ii) deposited, on the transparent substrate 21 (specifically a glass substrate), a silicon nitride film with a thickness of 50 nm as the wire reflectance reducing layer 27, and (iii) formed the above wires on the transparent substrate 21. The inventors thus successfully halved a light fraction reflected by the wires and thus traveling from the back surface of the substrate 20 serving as the front substrate (the back surface being a surface opposite to a surface that faces the PDLC layer 40).

The inventors (i) deposited, on the transparent substrate 21 (specifically a glass substrate), a titanium oxide film with a thickness of 25 nm as the wire reflectance reducing layer 27 and (ii) formed the above wires on the transparent substrate 21 to more preferably reduce the light fraction, reflected by the wires, by a factor of approximately 20.

The inventors (i) deposited, on the transparent substrate 21 (specifically a glass substrate), a magnesium fluoride film with a thickness of 160 nm and a titanium oxide film with a thickness of 25 nm to collectively form a wire reflectance reducing layer 27, and (ii) formed the above wires on the transparent substrate 21 to even more preferably reduce the light fraction, reflected by the wires, by a factor of approximately 50.

In the case where the wire reflectance reducing layer 27 is a metal film as described above, the metal film is provided on the back surface of the wires and, according to need, in a region surrounding the wires.

In the case where the wire reflectance reducing layer 27 is a silicon nitride film as described above, the silicon nitride film may be provided (i) throughout the display region of the substrate 20 or (ii) on the back surface of the wires and, according to need, in a region surrounding the wires.

The PDLC panel 10 is, as illustrated in FIG. 1, provided with an anti-reflection film 14 on at least one surface (that is, a surface of at least one of the substrates 20 and 30 which surface is opposite to a surface that faces the PDLC layer 40). The anti-reflection film 14 serves to reduce or eliminate reflection of external light on the substrate surface (that is, surface reflection of the substrates 20 and 30).

The anti-reflection film 14 is preferably provided at least on the surface of the front substrate (that is, a substrate on the observer side) out of the two substrates 20 and 30.

The anti-reflection film 14 can suitably be, for example, (i) an AR (anti-reflective) film or a LR (low reflection) film both of which reduce reflection by interference, or (ii) a non-reflective film having a moth eye structure, with which a film has curved projections (referred to as “moth eye)”) along a surface and thus has a refractive index continuously varying along its thickness direction.

In the case of carrying out a three-dimensional display in which a display image looks as if it has popped up in the air, it is ideal to display such a figure in an empty space.

However, at least in the case where such a display is carried out above a substrate including glass or the like, external light becomes visible due to substrate surface reflection (approximately 4%, for a normal line direction of the substrate).

External light is, even if visible in the scattering portion 13 in which an image is displayed, not so perceptible, and causes only a little visual influence. If, however, external light becomes visible in the transparent portion 12, that is, a non-display section in which no image is displayed with use of light projected by a light source device such as the projector 3, visibility of such external light significantly ruins the effect that causes the image displayed in the scattering portion 13 to look as if it is suspended in the air.

In the case where the PDLC panel 10 includes no constituent that is, as described above, provided to be closer to the observer than the wires are and that prevents direct reflection by the wires, a display image will, if the PDLC panel 10 has a surface that has been subjected to no treatment, merely look like an image created on a glass surface.

However, providing the anti-reflection film 14 on a surface of the PDLC panel 10 as described above reduces or prevents reflection of external light on the surface of the substrates 20 and 30, and thus makes it possible to carry out a unique three-dimensional display in which an image (video image) in the scattering portion 13 looks as if it has popped up in the air.

As described above, the PDLC panel 10 includes at least one of the constituents (1) and (2) below in order to reduce external light reflection that prevents carrying out of a three-dimensional display in which a display image looks as if it has popped up in the air.

(1) At least one selected from the group consisting of the light blocking film, the wire reflectance reducing layer 27, and the PDLC layer 40 (light scattering layer), each of which (i) is provided to be closer to the observer than the wires are and (ii) prevents direct reflection by the wires

(2) The anti-reflection film 14 that prevents reflection on the substrate surface

The PDLC panel 10 may include only one of the constituent (1) for preventing direct reflection by the wires and the constituent (2) for preventing reflection on the substrate surface. The PDLC panel 10, however, preferably includes both the constituents (1) and (2). The PDLC panel 10, in the case where it includes both the constituents (1) and (2), (i) has both functions described above and consequently (ii) achieves, due to a synergistic effect of the two functions, a greater effect of carrying out a display in which an image in the scattering portion 13 looks as if it has popped up in the air.

PDLC is, in many cases, disadvantageously degraded due to ultraviolet radiation such as sunlight.

In view of this disadvantage, the anti-reflection film 14, in the case where it is provided on the surface of the PDLC panel 10 as described above, has preferably been treated so as not to transmit UV light. The anti-reflection film 14 can, for example, be treated so as to have a UV absorption property.

In the case where the anti-reflection film 14 is not used, desirably (i) the PDLC panel 10 is provided, on a surface thereof, with a film that has been treated so as to, for example, have a UV absorption property and thus not to transmit UV light, or (ii) at least one of the substrate surfaces is directly treated so as not to transmit UV light.

The above measures against UV light are desirably carried out for both of the substrates 20 and 30.

[Display Operation]

The following describes a display operation of the display system 1.

The display system 1 causes (i) the PDLC panel 10 to serve as a display section (screen section) and (ii) the projector 3 to project light (video image) onto the PDLC panel 10.

In the PDLC panel 10, selectively applying an electric field to each pixel 11 enables selective formation of a transparent portion 12 (light transmitting region) and a scattering portion 13 (light scattering region).

The description below deals with an example case of the normal mode, in which the PDLC panel 10 is in (i) a light transmitting state when an electric field is applied thereto (ON state) and (ii) a light scattering state when no electric field is applied (OFF state). The same display operation is carried out in the reverse mode except that the PDLC panel 10 is in (i) the light scattering state when an electric field is applied thereto (ON state) and (ii) the light transmitting state when no electric field is applied (OFF state).

The PDLC panel 10 includes no CF. A pixel 11 is, when an electric field is applied thereto, in a transparent state (see-through state) having high transmittance (panel transmittance) since there is no CF. This allows a video image to be displayed only in the scattering portion 13 as illuminated by light from the projector 3 provided to be farther away from the observer (on a back surface side of the PDLC panel) than the PDLC panel is.

The PDLC panel 10 is transparent in the transparent portion 12 (that is, pixels 11 of transmissive display), through which the background is visible.

Since the PDLC panel 10 includes no CF, the scattering portion 13 can display light of any color projected by the projector 3.

Since the PDLC panel 10 itself does not carry out a color display as described above, the pixels 11 need not be each divided into three segments for R, G, and B. This allows the PDLC panel 10 to (i) be designed to have a high aperture ratio and thus (ii) achieve a transparent state having higher transmittance.

In the case where the projector 3 is used as a light source device as described above so that light projected onto the PDLC panel 10 is a projector video image, the projector 3 outputs a video image, such as a video image of a character, which is to be displayed on the PDLC panel 10 (see FIG. 1). The PDLC panel 10 forms a scattering portion 13 shaped by filling up a video image (for example, a video image of a character) corresponding to at least a portion, other than a black portion, of a video image (for example, a video image of a character) outputted by the projector 3 to be displayed on the PDLC panel 10.

In the case where a video image to be displayed on the PDLC panel 10 is, for example, of a person as illustrated in FIG. 8, expressing black of, for example, hair does not necessarily require the scattering portion 13 to display a black video image if the background seen through (that is, transmissively displayed in) the transparent portion 12 of the PDLC panel 10 is completely dark. This case simply requires a black portion to be a transparent portion 12 to express black so that the black background is transmissively displayed in the transparent portion 12.

In the case where, however, the background of the PDLC panel 10 is bright, that is, it is bright behind the PDLC panel 10, the PDLC panel 10 forms a scattering portion 13 shaped by filling up a video image (for example, a video image of a character) outputted by the projector 3 to be displayed on the PDLC panel 10. This prevents gray scale reversal and allows black of, for example, hair to be expressed. Thus, in this case, the PDLC panel 10 forms a scattering portion 13 shaped by filling up, for example, a character image or the like outputted by the projector 3.

In other words, the PDLC panel 10 forms (i) for a portion to display a video image having a color identical to the background color, not a scattering portion 13 but a transparent portion 12 and (ii) for at least a portion to display a video image having a color that is different from the background color, a scattering portion 13 shaped by filling up a video image.

In the case where the background is bright as described above, the scattering portion 13 preferably uniformly has a zero gray scale in the normal mode. In the case where the background is dark, on the other hand, a voltage may be applied to the scattering portion 13, provided that such voltage application causes no gray scale reversal.

The PDLC panel 10, as described above, causes (i) the scattering portion 13 to display a video image projected by a light source device such as the projector 3 and (ii) the transparent portion 12 to transmissively display the background of the PDLC panel 10. The PDLC panel 10 consequently displays a combination of (i) the background of the PDLC panel 10 and (ii) the video image projected by a light source device such as the projector 3.

[Operating Principle]

The following describes an operating principle of the display system 1.

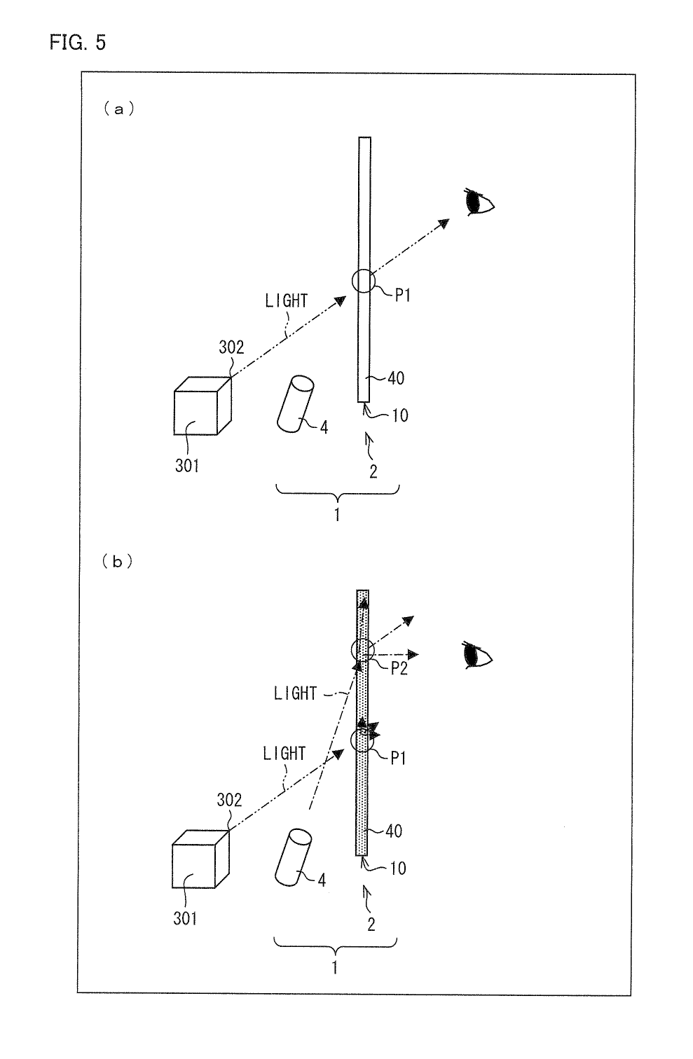

(a) and (b) of FIG. 5 are each a diagram illustrating the operating principle of the display system 1. (a) of FIG. 5 illustrates an operating principle of the display system 1 for the case in which the PDLC layer 40 of the PDLC panel 10 is controlled to be in a light transmitting state. (b) of FIG. 5 illustrates an operating principle of the display system 1 for the case in which the PDLC layer 40 of the PDLC panel 10 is controlled to be in a light transmitting state.

The description below deals with an example case in which (i) an object 301 is provided behind the PDLC panel 10 (that is, in the background of the PDLC panel 10) and (ii) it is not completely dark behind the PDLC panel 10, that is, the background of the PDLC panel 10 is not completely dark, but it is instead bright behind the PDLC panel 10 due to external light such as illumination light.

The following first describes an example case involving, as described above, the projector 3 as a light source device 4 illustrated in (a) and (b) of FIG. 5.

When the PDLC layer 40 of the PDLC panel 10 is controlled to be in the light transmitting state as illustrated in (a) of FIG. 5, light (image) that has been (i) reflected by the object 301, located behind the PDLC panel 10 as viewed from an observer, at an angle 302 and thus (ii) incident upon the PDLC panel 10 is transmitted at a position P1 without being scattered. The figure (image) of the object 301 is clearly seen by the observer as a result.

In the case illustrated in (b) of FIG. 5, on the other hand, light that has been (i) reflected by the object 301 at the angle 302 and thus (ii) incident upon the PDLC panel 10 is scattered at the position P1.

The light reflected by the object 301, which light has no directivity, reaches the vicinity of the position P1 of the PDLC panel 10 as well and is then scattered.

Further, at the position P1, light reaches and is scattered which is reflected by the object 301 at an angle other than the angle 302, that is, reflected by the object 301 at its side and surface. This prevents the observer from being able to see a sharp figure of the object 301 behind the PDLC panel 10.

In the case where the light source device 4 provided behind the PDLC panel 10 is the projector 3 as described above, focusing the projector 3 on, for example, a position P2 of the PDLC panel 10 causes light projected by the projector 3 (that is, the light source device 4) and scattered at the position P2 to be forward-scattered at the PDLC panel 10 and then reach the observer. The light projected on the position P2, however, includes only information on, for example, brightness and color of an image to be displayed at the position P2. This allows the observer to clearly see the figure projected by the projector 3. This principle applies also to the case in which the light projected by the light source device 4 is light with directivity, as in the case where the light source device 4 is, for example, a laser projector.

In the case where the light source device 4 is a light source device that projects monochromatic light, it is simply necessary to focus the light source device 4 on the PDLC panel 10 or select a light source device 4 with directivity in order to control, as described above, (i) the PDLC panel 10 between the light transmitting state and the light scattering state and (ii) the ON/OFF state of light from the light source device 4.

In the case where the light source device 4 is a light source device that projects monochromatic light as described above, the light source device 4 may alternatively be set so that (i) the shape of a figure to be displayed on the PDLC panel 10 is expressed with use of the light transmitting state and the light scattering state of the PDLC panel 10 and that (ii) light from the light source device 4 irradiates the entire surface of the PDLC panel 10. In this case, light from the light source device 4 enters the transparent portion 12 of the PDLC panel 10 as well. Thus, the light source device 4 is desirably positioned such that light projected by the light source device 4 does not directly reach the observer.

The present embodiment indicates that in the case where the light source device 4 is, as described above, a light source device that projects light having a single color or multiple colors (colored light), (i) a color display can be carried out without use of a CF, and (ii) the observer can see the background of the PDLC panel 10 through the PDLC panel 10 due to the above operating principle. The present embodiment is therefore not influenced by a transmittance decrease arising from the use of a CF, and can carry out a see-through display having high transparency as a result.

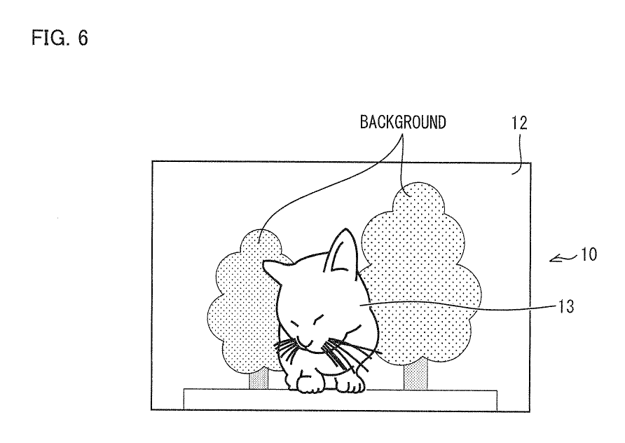

FIG. 6 is a diagram illustrating an example image displayed on the PDLC panel 10.

FIG. 6 illustrates a display image formed by a combination of (i) a projected image, that is, a light-scattered image, and (ii) the background, that is, a light-transmitting image, the projected image and the background having been formed by, as illustrated in FIG. 1, (i) causing a video image projected by the projector 3 to be displayed in a scattering portion 13 having a shape identical to the shape formed by the outline of the video image projected by the projector 3 and (ii) causing a region surrounding the video image to be a transparent portion 12.

In the case where, as described above, the background of the PDLC panel 10 is not completely dark, and is in a state in which, for example, illumination is provided (that is, in a state in which the background is visible), the projected image, that is, a light-scattered image, looks as if it has popped up in the air from the background, that is, a light-transmitting image, in the composite image illustrated in FIG. 6. In other words, it is possible to carry out a unique display in which a projected image looks as if it has popped up in the air from the surface of the PDLC panel 10.

The video image projected by the projector 3 can be shaped in any manner by, for example, randomly changing the respective shapes of the transparent portion 12 and the scattering portion 13. Further, the video image can be combined with the background for various unique displays.

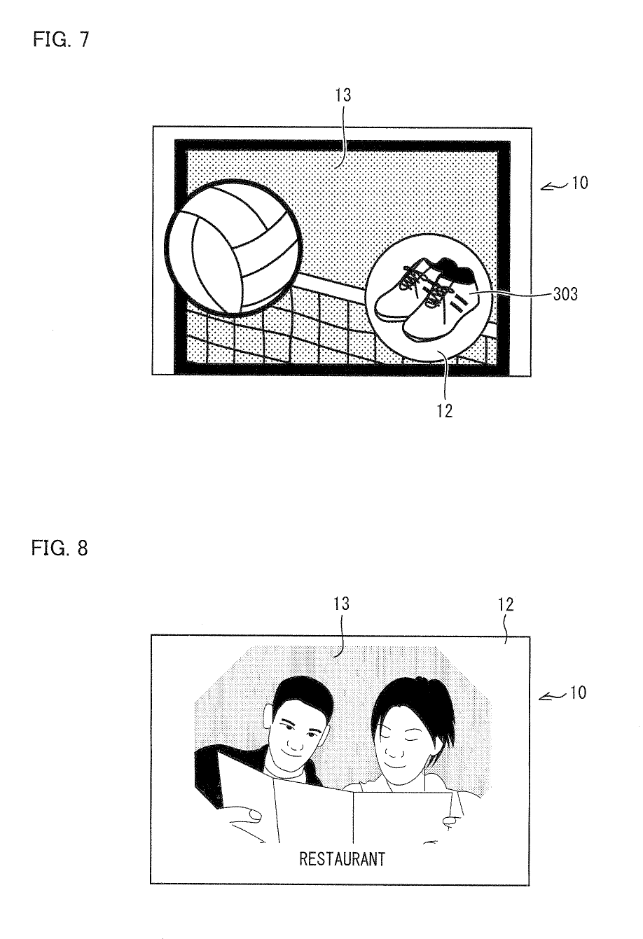

FIG. 7 is a diagram illustrating an example display image in which a transparent portion 12 is formed inside a scattering portion 13 on the PDLC panel 10. FIG. 7 indicates that a transparent portion 12 in any shape can be formed inside a scattering portion 13. FIG. 7 illustrates an example in which real shoes 303 (commodity) as the above object 301 are placed behind the PDLC panel 10 as viewed from the observer (that is, in the background of the PDLC panel 10).

FIG. 8 is a diagram illustrating an example display image in which, as contrary to the example of FIG. 7, a scattering portion 13 is formed inside a transparent portion 12 on the PDLC panel 10. FIG. 8 indicates that a video image, text and the like in any shape can be displayed.

[Video Image Processing]

The following describes a video image processing in the display system 1.

In the case where the light source device 4 is a projector 3 that displays an image (video image) as described above, an image formed on the PDLC panel 10 by the transparent portion 12 and the scattering portion 13 needs to be synchronized with an image displayed by the projector 3.

The description below thus deals, as a video image processing in the display system 1, with a method of synchronizing the two images.

The following describes, before the above method, a schematic configuration of the display device 2 of the display system 1 with reference to FIG. 9.

As illustrated in FIG. 9, the display device 2 includes, other than the PDLC panel 10, members such as a data receiving section 51, a data reception control section 52, an arithmetic operation control section 53, a video image control section 54, a storage section 55, and an operation section 56.

The data receiving section 51 receives, by a wired or wireless means, a video signal (for example, (i) image data representative of a mixture of a character and text and (ii) audio data) from an external device under reception control by the data reception control section 52. In the case where the above external device is assumed to be a recording medium such as a memory card, the data receiving section 51 may receive the video signal through a slot in which the recording medium is to be inserted. The video signal thus received is transmitted to the arithmetic operation control section 53.

The arithmetic operation control section 53 creates an image from the video signal received by the data reception control section 52 which image is to be displayed on the PDLC panel 10. The image thus created is transmitted to (i) the video image control section 54 and also to (ii) the storage section 55 to be stored therein. The arithmetic operation control section 53 performs an arithmetic operation in accordance with an instruction received from the operation section 56.

The video image control section 54 converts the image created by the arithmetic operation control section 53 into an image to be displayed on the PDLC panel 10, and transmits the converted image to the PDLC panel 10. The video image control section 54 further converts the image created by the arithmetic operation control section 53 into an image to be outputted from the projector 3, and transmits the converted image to the projector 3.

In this example, the image to be transmitted to the PDLC panel 10 is an image formed as if by filling up the inside of the outline of an image (for example, an image of a character or text) to be outputted by the projector 3 and thus displayed on the PDLC panel 10. The image to be transmitted to the PDLC panel 10 is, for example, an image formed as if by filling up, as illustrated in FIG. 1, an image of a character or the like included in the above image.

To appropriately display an image with use of the projector 3 and the PDLC panel 10 in the display system 1 including the above display device 2, it is necessary to, as described above, synchronize the image of the projector 3 with the image of the PDLC panel 10 for display.

In other words, in the case where the projector 3 is, for example, a projector that displays an image, it is necessary to, as described above, cause the image of the PDLC panel 10 to correspond in display timing to the image of the projector 3.

[Timing Control]

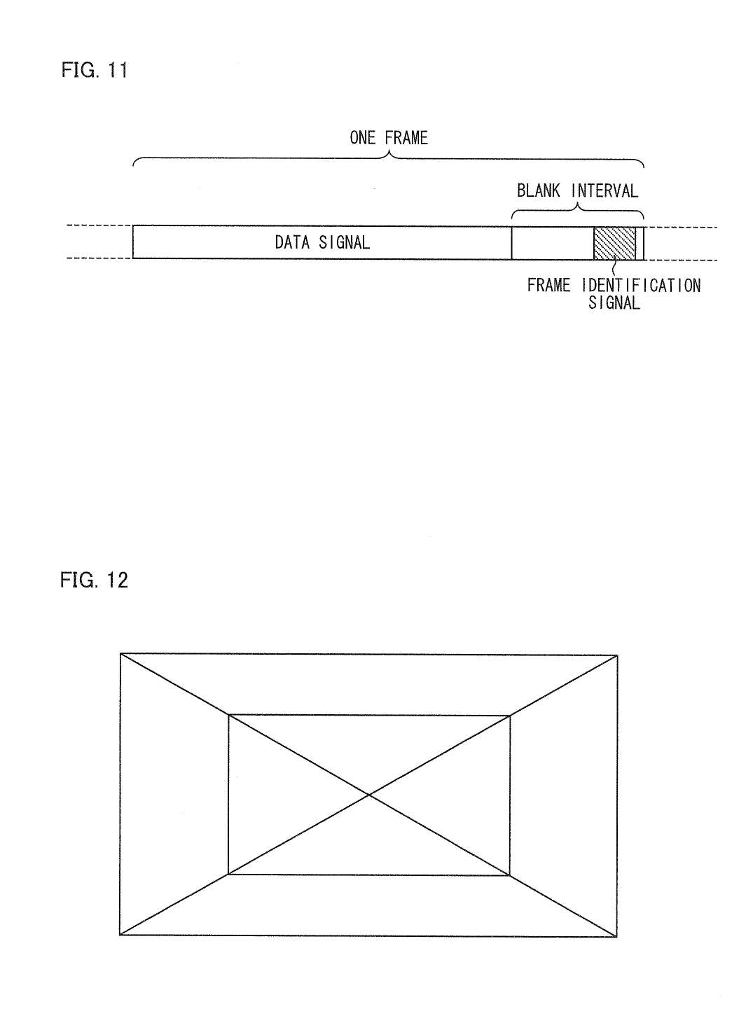

FIG. 10 illustrates a circuit configuration of the video image control section 54 for the case in which the light source device 4 is a projector 3 as described above. FIG. 11 illustrates a makeup of a frame.

The video image control section 54 includes, as illustrated in FIG. 10, (i) a display control circuit 61, (ii) a panel display control circuit 62 that causes the PDLC panel 10 to display an image on the basis of a data signal transmitted from the display control circuit 61, (iii) a light source display control circuit 63 that causes the projector 3 to output an image on the basis of a data signal transmitted from the display control circuit 61, and (iv) a feedback circuit 64 that transmits, to each of the panel display control circuit 62 and the light source display control circuit 63, a display control signal that is for use in achieving synchronization between (i) a timing at which the panel display control circuit 62 causes the PDLC panel 10 to display an image and (ii) a timing at which the light source display control circuit 63 causes the projector 3 to output an image.

Further provided is an audio output section (not shown) that outputs audio data in the form of a sound, the audio output section being connected to the arithmetic operation control section 53 and the feedback circuit 64.

The display control circuit 61 generates signals from the image created by the arithmetic operation control section 53 which signals (that is, data signals indicating respective gray scales of the individual pixels 11 for each frame) are indicative of an image to be displayed on the PDLC panel 10. The display control circuit 61 then transmits the signals to the panel display control circuit 62.

The display control circuit 61 further generates signals from the image created by the arithmetic operation control section 53 which signals (that is, data signals indicating respective gray scales of the colors of the individual pixels 11 for each frame) are indicative of an image to be outputted by the projector 3. The display control circuit 61 then transmits the signals to the light source display control circuit 63.

The above data signals are transmitted to each of the panel display control circuit 62 and the light source display control circuit 63 together with a frame identification signal for identifying a corresponding frame. In this case, the data signals are transmitted during, for example, a former half of one frame (see FIG. 11), whereas the frame identification signal is transmitted during a latter half, that is, a blank interval, of the frame. In other words, the data signals and the frame identification signal are transmitted to each of the circuits as data corresponding to one frame.

The panel display control circuit 62 and the light source display control circuit 63 each transmit the frame identification signal, included in the above-transmitted data corresponding to one frame, to the feedback circuit 64. The feedback circuit 64 then determines, on the basis of the respective frame identification signals transmitted thereto, whether the frame identification signals identify an identical frame. If the feedback circuit 64 has determined that the frame identification signals identify an identical frame, the feedback circuit 64 transmits, to each of the panel display control circuit 62 and the light source display control circuit 63, a display control signal for causing an image to be displayed simultaneously.

The panel display control circuit 62, in response to the display control signal transmitted thereto, transmits the data signals, which have already been transmitted thereto, to the PDLC panel 10 to cause the PDLC panel 10 to display an image. Simultaneously to this operation, the light source display control circuit 63, in response to the display control signal transmitted thereto, transmits the data signals, which have already been transmitted thereto, to the projector 3 to cause the projector 3 to output an image.

Using the video image control section 54 of FIG. 10 as described above allows the PDLC panel 10 and the projector 3 in the display system 1 to display their respective images in synchronization with each other. In this case, (i) the image outputted by the projector 3 is displayed only in the scattering portion 13 of the PDLC panel 10, and (ii) the transparent portion 12 of the PDLC panel 10 is in a transparent state (see-through state) having high panel transmittance since there is no CF.

This arrangement makes it possible to (i) carry out a display in which an image (video image) looks as if it has popped up from the background behind (that is, on a back surface side of) the PDLC panel 10 and (ii) carry out such a display in synchronization with a sound.

The PDLC panel 10 displays, in the scattering portion 13, an image with use of light projected by the projector 3. Thus, causing the projector 3 to project light, as described above, only onto the scattering portion 13 formed on the PDLC panel 10 makes it possible to carry out a clear and high-resolution display and reduce power consumption.

[Alignment]

Appropriately displaying an image from the projector 3 in the scattering portion 13 as described above requires overlaying the image from the projector 3 on the scattering portion 13 of the PDLC panel 10.

The following describes methods of aligning the image of the PDLC panel 10 with the image of the projector 3 in the display system 1.

The alignment methods include a manual alignment method and an automatic alignment method.

[Manual Alignment]

For the display system 1 having, for example, the configuration illustrated in FIG. 9, a user manually carries out the alignment.

FIG. 12 is a diagram illustrating a pattern for manually aligning the image of the PDLC panel 10 with the image of the projector 3.

In this case, the manual alignment involves causing each of the PDLC panel 10 and the projector 3 to display, in a size equal to or smaller than the size of a display screen, a pattern such as that illustrated in FIG. 12, which includes a central point, vertical lines, horizontal lines, and diagonal lines.

When the PDLC panel 10 and the projector 3 are set up, the user adjusts each of the image of the PDLC panel 10 and the video image of the projector 3 in terms of, for example, (i) a position, (ii) an angle, (iii) a focus, and (iv) a trapezium distortion so that the image of the PDLC panel 10 and the video image of the projector 3 match each other with respect to the central point, vertical lines, horizontal lines, and diagonal lines. This allows the alignment to be carried out manually.

[Automatic Alignment]

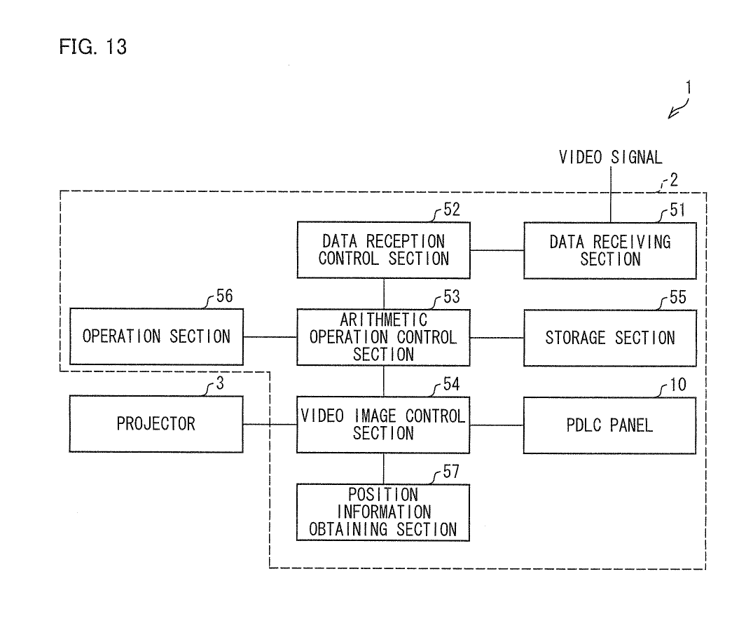

The following describes the automatic alignment method with reference to FIGS. 13 through 16.

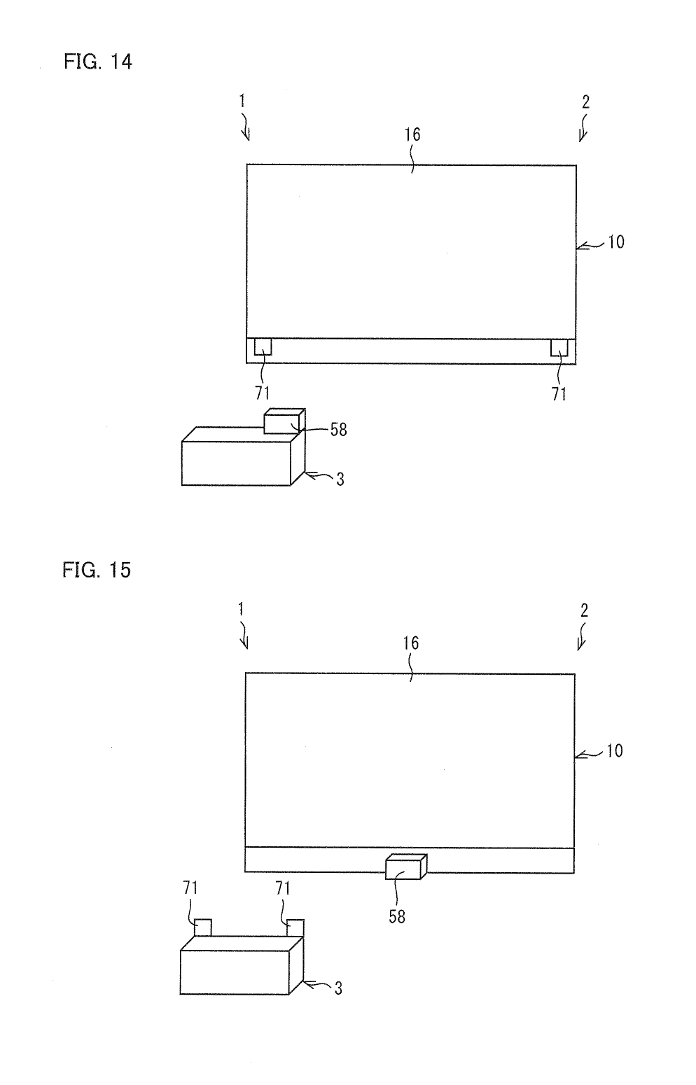

FIG. 13 is a block diagram illustrating an example schematic configuration of the display system 1 for automatically carrying out the above alignment. FIGS. 14 through 16 are each a perspective view illustrating another example schematic configuration of the display system 1 for automatically carrying out the above alignment.

In the case where the above alignment is carried out automatically as described above, such an automatic alignment can be carried out by, for example, providing a position information obtaining section 57 in the display device 2 as illustrated in FIG. 13, the position information obtaining section 57 obtaining (i) information on a position of the PDLC panel 10 relative to the projector 3 or (ii) information on a position of the projector 3 relative to the PDLC panel 10.

The automatic alignment may alternatively be carried out as illustrated in FIG. 14. Specifically, the PDLC panel 10 is provided, outside its display area 16, with retro-reflective plates 71 and 71. The projector 3 is provided with a sensor 58 including a light-receiving element and a light-emitting element. The light-receiving element of the sensor 58 receives reflected light from the retro-reflective plates 71 and 71, so that the sensor 58 outputs a value. The above position information is detected on the basis of the output value.

The automatic alignment may further alternatively be carried out as illustrated in FIG. 15. Specifically, the projector 3 is provided with retro-reflective plates 71 and 71. The PDLC panel 10 is provided, outside its display area 16, with a sensor 58 including a light-receiving element and a light-emitting element. The light-receiving element of the sensor 58 receives reflected light from the retro-reflective plates 71 and 71, so that the sensor 58 outputs a value. The above position information is detected on the basis of the output value.

The above position information may be detected through (i) a trigonometrical survey system based on the output value of the sensor 58 or (ii) a phase difference distance-measuring system involving use of a laser light source (which is a light source other than the projector 3).

The position information detected as above is transmitted to the position information obtaining section 57 illustrated in FIG. 13. The position information obtained by the position information obtaining section 57 is transmitted to the video image control section 54.

The video image control section 54 makes various adjustments to the projector 3 on the basis of the position information for alignment (position correction) of the image of the PDLC panel 10 with the image of the projector 3.

Specifically, if there occurs a trapezium distortion in a video image from the projector 3 due to the positioning of the projector 3 relative to the PDLC panel 10, the video image control section 54 corrects the trapezium distortion. If light is projected by the projector 3 in an inappropriate direction, the video image control section 54 adjusts the projection direction. If the projector 3 is out of focus, the video image control section 54 focuses the projector 3.

The above alignment (position correction) is carried out when the PDLC panel 10 and the projector 3 are set up, and may also temporarily be carried out when, for example, alignment is necessary after the setting up for a reason.

Thus, the above members for detecting position information, namely the retro-reflective plates 71 and 71 and the sensor 58, may be (i) temporarily set up only when alignment is to be carried out or (ii) always attached. Further, the above alignment may be carried out regularly.

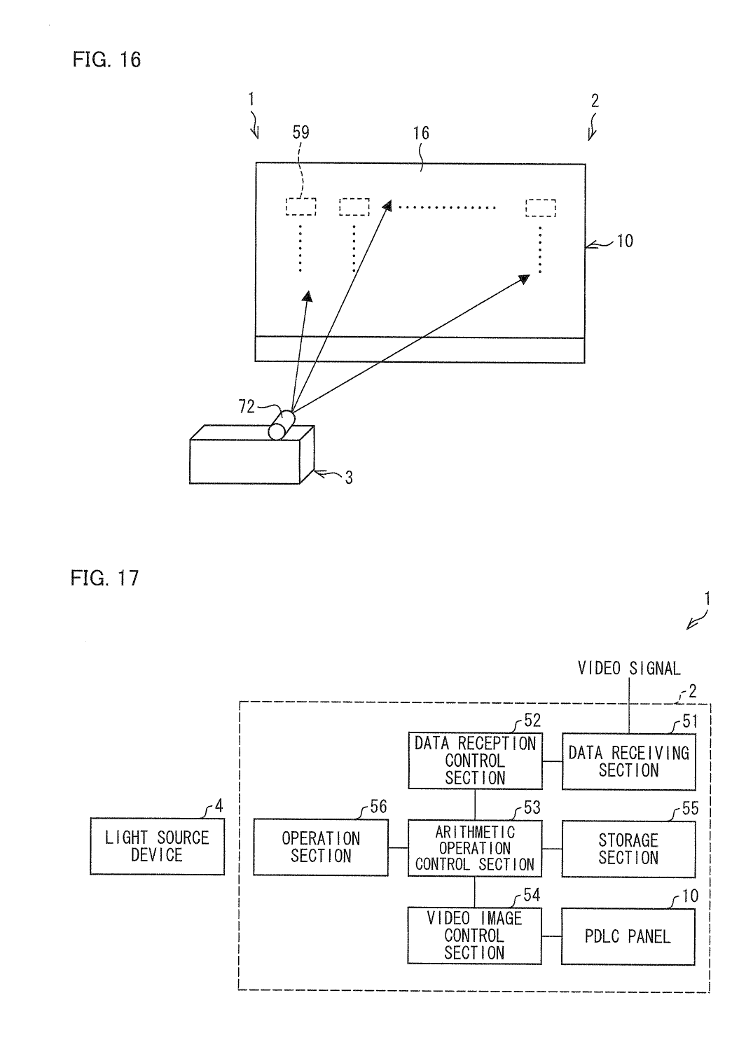

In the display system 1 illustrated in FIG. 16, (i) the PDLC panel 10 includes, inside the display area 16, sensors 59 (in-pixel sensors) each including a light-receiving element and (ii) the projector 3 is provided with a sensor light source 72 for emitting light to the sensors 59 inside the display area 16 of the PDLC panel 10. The sensors 59 are different from the sensor 58 illustrated in FIGS. 14 and 15, and thus each include no light-emitting element.

In the display system 1 with the above configuration, the sensor light source 72 emits light to at least three positions in their respective directions. Since the PDLC panel 10 includes the sensors 59, which are in-pixel sensors, the display system 1 can detect a position inside the display area 16 of the PDLC panel 10 which position the sensor light source 72 irradiates with light. This arrangement makes it possible to accurately detect the respective positions of the transparent portion 12 and the scattering portion 13 inside the display area 16.

The display system 1 with the above configuration can accurately adjust the transparent portion 12 and the scattering portion 13 inside the display area 16. The display system 1 can thus create an optimal video image that is free from a positional shift between the image of the PDLC panel 10 and the image of the projector 3.

The example illustrated in FIG. 16 involves using, as described above, the sensor light source 72 provided to the projector 3 serving as the light source device 4. The sensor light source 72 is, however, not necessarily an essential member.

In the case where the light source device 4 is provided with no sensor light source 72, the light source device 4 emits light in three or more directions toward the display area 16 of the PDLC panel 10 to carry out a process similar to the above, so that the display system 1 can detect a position inside the display area 16 of the PDLC panel 10 which position the light source device 4 irradiates with light. This arrangement also makes it possible to accurately detect the respective positions of the transparent portion 12 and the scattering portion 13 inside the display area 16.

Further, an optimal video image can also be created as follows: The above position information, obtained with use of the sensors 59 inside the pixels 11 of the PDLC panel 10, is transmitted to the light source device 4 such as the projector 3 regardless of whether or not the sensor light source 72 is used. This makes it possible to, without changing a display position of the PDLC panel 10, (i) adjust the light emission direction of the light source device 4, (ii) correct a distortion of the light source device 4, and if necessary (iii) focus the light source device 4.

The above description deals with a method in which (i) the light source device 4 is, for example, a projector 3, and (ii) alignment is carried out between the image of the PDLC panel 10 and the image of the projector 3.

There is, however, no need to carry out alignment between the image of the PDLC panel 10 and the image of the projector 3 in the case where light is projected onto the entire display area 16 of the PDLC panel 10. There is also no need to carry out alignment between the image of the PDLC panel 10 and the image of the projector 3 in the case where, for example, (i) the light source device 4 is an LED, and (ii) monochrome or multicolor light is projected onto the entire display area 16 or a partial region thereof in the PDLC panel 10, for example, in the case where the PDLC panel 10 displays a still image. There is, as described above, no need to carry out alignment between the image of the PDLC panel 10 and the image of the projector 3 in the case where an image is displayed only in a partial region of the scattering portion 13.

In the above cases, there is, for example, no need for the video image control section 54 to (i) convert the image created by the arithmetic operation control section 53 into an image to be outputted by the light source device 4 and thus (ii) transmit data of the converted image to the light source device 4.

In the above cases, the display system 1 can have, for example, a configuration illustrated in FIG. 17.

[Incidence Angle of Light from Light Source]

The following describes an incidence angle of light from the projector 3 to the PDLC panel 10 in the display system 1.

The display panel normally includes an insulating substrate with a refractive index (that is, a refractive index relative to the absolute refractive index of air) that falls within the range of approximately 1.45 to 1.65.

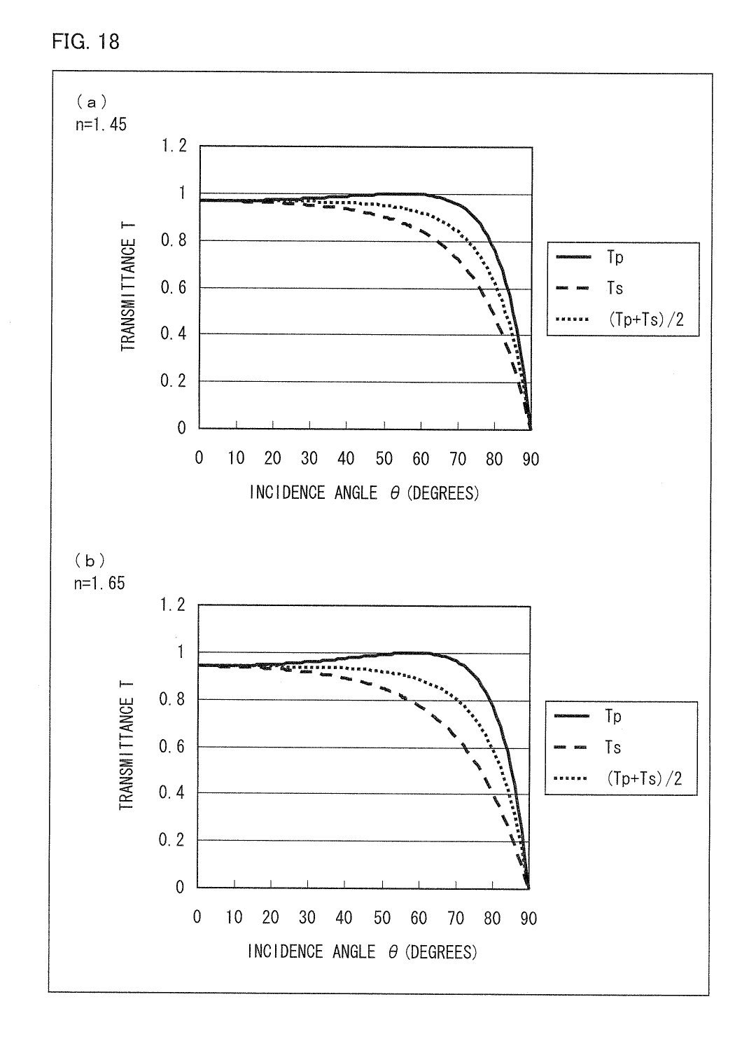

(a) and (b) of FIG. 18 each illustrate a relation between transmittance and a light incidence angle θ, where (i) the refractive index of the PDLC panel 10 on its entrance side is designated as 1, and (ii) the relative refractive index n of a surface of the PDLC panel 10 is 1.45 for (a) or 1.65 for (b).

More specifically, (a) of FIG. 18 illustrates an example of dependence of the panel transmittance on the light incidence angle for the case in which the front substrate and the back substrate are each made of silica glass having a refractive index of 1.45 relative to the absolute refractive index of air. (b) of FIG. 18 illustrates an example of dependence of the panel transmittance on the light incidence angle for the case in which the front substrate and the back substrate are each a plastic substrate that is made of polyether sulfone (PES) and that has a refractive index of 1.65 relative to the absolute refractive index of air.

In (a) and (b) of FIG. 18, (i) Tp represents transmittance for a polarized light component (P polarized light) parallel to a light incidence surface of the PDLC panel 10, (ii) Ts represents transmittance for a polarized light component (S polarized light) perpendicular to the light incidence surface of the PDLC panel 10, and (iii) the incidence angle θ represents an angle of light incident on a farther end of the PDLC panel 10 from the projector 3 serving as the light source device 4, that is, a maximum angle of light (projection light) entering the PDLC panel 10 from the projector 3.

As illustrated in (a) and (b) of FIG. 18, the transmittance abruptly drops at an incidence angle θ exceeding 80 degrees. This prevents light projected by the projector 3 from entering the PDLC panel 10 efficiently. However, as illustrated in (a) and (b) of FIG. 18, the transmittance of approximately 60% is achieved at an incidence angle θ of 80 degrees.

Thus, in the case where the incidence angle θ is 80 degrees or less, preferably 75 degrees or less, more preferably 70° or less, or even more preferably 65 degrees or less, it is possible to carry out a display having high transmittance and even brightness.

The incidence angle θ, that is, the incidence angle of light from the projector 3 to the PDLC panel 10, is at its maximum particularly preferably equal to or smaller than the Brewster's angle (hereinafter referred to as “Brewster's angle θb”).

The Brewster's angle θb is an incidence angle at which light reflected at the interface between materials having different refractive indexes becomes complete S polarized light. In other words, the Brewster's angle θb is an angle defined by θb=arctan(n2/n1), where n1 represents a refractive index of the PDLC panel 10 on its entrance side, and n2 represents a refractive index of the PDLC panel 10 on its transmission side. The polarized light component (P polarized light) parallel to the incidence surface has a reflectance of 0 at this angle.

Light entering glass from the air has a Brewster's angle θb of appropriately 56 degrees. Light entering a plastic substrate having a relative refractive index of 1.65 has a Brewster's angle θb of approximately 59 degrees.

When the polarized light component (S polarized light) parallel to the incidence surface is also taken into consideration, the transmittance does not change much with respect to the incidence angle θ until the Brewster's angle is reached. Once the incidence angle θ exceeds the Brewster's angle, however, the reflectance increases abruptly, so that light entering the PDLC panel 10 from the projector 3 is decreased.

Thus, if the projector 3 is set up such that light from the projector 3 to the PDLC panel 10 has an incidence angle θ that at its maximum greatly exceeds the Brewster's angle, the PDLC panel 10 will carry out a display that is uneven in brightness over the surface of the PDLC panel 10.

In particular, an incidence angle θ of greater than 80 degrees abruptly decreases the transmittance as described above. The incidence angle θ is thus preferably 80 degrees or less as described above.

[Positional Relationship between Light Source and Lines]

The following describes a positional relationship between the projector 3 and the wires in the PDLC panel 10.

The PDLC panel 10 is preferably designed to be capable of being driven at, for example, 10 V so that the power consumption is low or that commonly used drivers can be included. In other words, for the PDLC panel 10, the materials, production conditions, cell thickness and the like are preferably set so that the PDLC panel 10 can be driven at 10 V or lower by a TFT drive.

When such a PDLC panel 10 is in a light scattering state, light incident upon a panel aperture is, for example, 80% forward-scattered and 5% backward-scattered, and the remaining 15% is lost due to (i) reflection or absorption by the individual layers (films) inside the panel or (ii) light guide through the panel.

This indicates that since the above PDLC panel 10 is mostly forward-scattering, the projector 3 is desirably placed behind the PDLC panel 10 as viewed from the observer for effective use of light from the projector 3.

In the case where the PDLC panel 10 with such strong forward scattering is used, placing the projector 3, serving as the light source device 4, behind the PDLC panel 10 as viewed from the observer achieves higher efficiency of use of light from a light source and makes it possible to create a clear and bright display image.

The projector 3 may be placed in front of the PDLC panel 10 in the case where the PDLC layer 40 is placed in front of the wires as viewed from the observer, that is, in the case where the substrate 20, which is an active matrix substrate, serves as the back substrate as described above.

In the case where (i) the substrate 20 serves as the back substrate as described above and (ii) the projector 3 is placed behind the substrate 20 as viewed from the observer, light projected by the projector 3 is reflected by the wires before passing through the PDLC layer 40.

In the case where the projector 3 is placed on the front substrate side, that is, in front of the substrate 30 as viewed from the observer, light projected by the projector 3 first passes through the PDLC layer 40 and is then reflected by the above wires (that is, the source wires 24, gate wires 25, and Cs wires 26) if the wires, particularly the Cs wires 26, are not completely blocked by the black matrix 32 from light.

Thus, in the case where, as described above, (i) no light blocking film is provided in front of the wires as viewed from the observer and (ii) the PDLC layer 40 is provided in front of the wires (that is, the substrate 20, which is an active matrix substrate, serves as the back substrate as described above), light from the projector 3 reaches the observer efficiently due to the respective effects of (i) reflection by the wires and (ii) scattering by the PDLC layer 40, that is, a light scattering layer, even if the projector 3 is placed in front of the PDLC panel 10 as viewed from the observer.

In other words, in the case where the projector 3 is placed to be closer to the observer than the PDLC panel 10 is, the projector 3 is desirably placed on the substrate 30 (counter substrate) side. To achieve high efficiency of use of light from the projector 3, there is desirably no light blocking film provided in front of the wires (particularly in front of the Cs wires 26 as described above) as viewed from the observer.

[Transmittance]

The following describes transmittance of the PDLC panel and a relation between the transmittance and the above-mentioned design (for example, a material, production conditions, and a cell thickness) of the PDLC panel 10.

The PDLC panel 10, in the light transmitting state (that is, when it is transparent), has a transmittance within the range of 40% to 90% and thus achieves a light transmitting state having high transparency. The PDLC panel 10, in the light scattering state (that is, when light is scattered), has a transmittance within the range of 0.1% to 30% and can thus carry out a black display through which the background is not seen.

A PDLC panel including a pair of substrates (namely, the front substrate and the back substrate) each made of glass provided with only a transparent electrode achieves, in a light transmitting state, a transmittance of 79% to 90% for a direction normal to the panel with respect to the transmittance of 100% for air. In such a state, light scattering by the PDLC was sufficiently low, and the PDLC panel was able to carry out a display having high transparency.

In contrast, the PDLC panel 10 (TFT panel) including a TFT substrate as described above achieves a transmittance within the range of 70% to 80% in its panel aperture portion due to influence by a transparent resin layer and insulating layers. This indicates that a TFT panel can achieve a light transmitting state with high transparency if it can achieve a transmittance of at least 70%×(panel aperture ratio).

On the other hand, the PDLC panel 10, in a light scattering state, was able to carry out, with a transmittance of 30% or lower, a display through which the background was not seen.

In a light scattering state, with a transmittance exceeding 30%, of the PDLC panel including a pair of substrates each made of glass provided with only a transparent electrode, (i) there was a limit to a light source position at which light sufficiently reaches the observer due to scattering, and (ii) the PDLC panel was unable to carry out a display exhibiting sufficient contrast in response to the ON/OFF switching of a voltage.

A TFT panel thus more preferably has a light scattering state in which a transmittance of not greater than 27%×(panel aperture ratio) allows light to more sufficiently reach the observer due to scattering.

Achieving the above light transmitting state and light scattering state greatly depends on selection of materials (for example, PDLC, a wire material, and a material of the transparent conductive film) in the drive layers of the PDLC panel 10. Another approach to lowering transmittance of the light scattering state is, for example, increasing the cell thickness (that is, the thickness of the PDLC layer).

Increasing the cell thickness increases the distance for scattering, and thus increases scattering. Increasing the cell thickness in the PDLC panel 10, however, will lead to an increase in driving voltage.

As described above, the PDLC panel 10 desirably has materials, production conditions, cell thickness and the like to be capable of being driven at, for example, 10 V so that the power consumption is low or that commonly used drivers can be included.

Increasing the cell thickness as described above, however, will prevent sufficient transmittance from being achieved in a transparent state by the above-described TFT drive at 10 V or lower.

Thus, to achieve the above respective transmittances for the light transmitting state and the light scattering state, the PDLC panel 10 desirably has a cell thickness of not less than 3 μm and not greater than 15 μm.

[Method for Producing PDLC Panel]

The following describes a method for producing the PDLC panel 10.

The PDLC panel 10 can be produced by, for example, (i) mixing a polymerizable monomer, a photopolymerization initiator, and positive liquid crystal, (ii) filling the mixture between the substrates 20 and 30 by a method such as one drop filling so that the mixture is contained therebetween in a sealed manner, and then (iii) exposing the resulting product to UV radiation (that is, photopolymerization).

The above polymerizable monomer, photopolymerization initiator, and positive liquid crystal are not particularly limited in terms of kind, and can thus be publicly known materials commonly used for production of a PDLC panel. The above mixture is also not particularly limited in terms of composition (use amounts), and the composition may thus be chosen as conventional. The kind and the composition are not described here; however, those skilled in the art will have a sufficient knowledge about them and can thus sufficiently implement the present embodiment.

The PDLC panel 10 of the present embodiment, as described above, includes no CF (colorless). Thus, regardless of whether the PDLC is exposed from the substrate 20 side or the substrate 30 side, there occurs no UV absorption by a CF. In other words, there occurs no UV absorption by a CF even if the PDLC is exposed from the side of the counter substrate, which would include a CF in conventional art. The above arrangement thus eliminates the need to use an exposure device having an extremely large illuminance, and thus allows for use of an exposure device that is widely in common use.

As described above, typical PDLC display modes include (i) a mode referred to as “normal mode”, in which a light scattering state is achieved when no electric field is applied, whereas a light transmitting state is achieved when an electric field is applied and (ii) a mode referred to as “reverse mode”, in which a light transmitting state is achieved when no electric field is applied, whereas a light scattering state is achieved when an electric field is applied.

The above mixture, which is a material of the PDLC, exhibits liquid crystallinity as a whole.

The PDLC panel 10 having the normal mode can be produced by exposing the mixture to UV (ultraviolet) radiation at a temperature not lower than a liquid crystal phase-isotropic phase transition temperature (Tₙᵢ) of the mixture, or desirably at a temperature that is not lower than the liquid crystal phase-isotropic phase transition temperature of the mixture and that is not higher than a liquid crystal phase-isotropic phase transition temperature of the positive liquid crystal used in the mixture.

In the PDLC panel 10 having the normal mode, the polymerizable monomer, which is a material of the mixture, is a material (non-liquid crystalline monomer) having no refractive index anisotropy in a polymer portion (that is, a region having a high polymer density as a result of phase separation due to UV polymerization) occurring when the PDLC is formed. Obtained liquid crystal droplets contain liquid crystal molecules that are randomly aligned in a direction of the panel surface.

The PDLC panel 10 having the reverse mode can be produced by exposing the mixture to UV radiation at a temperature not higher than the liquid crystal phase-isotropic phase transition temperature (Tₙᵢ) of the mixture, or desirably at a temperature that is not higher than the liquid crystal phase-isotropic phase transition temperature of the mixture and that is not lower than (i) a crystallization temperature of the mixture or (ii) a temperature at which obtained PDLC forms a smectic layer.

In the PDLC panel 10 having the reverse mode, the polymerizable monomer, which is a material of the mixture, is a material (liquid crystalline monomer) having refractive index anisotropy in a polymer portion occurring when the PDLC is formed. Obtained liquid crystal droplets contain liquid crystal molecules which are aligned such that the refractive index of the polymer is equal to that of the liquid crystal.

In the case where the PDLC panel 10 includes normal mode PDLC as the PDLC layer 40 serving as a light scattering layer, it is possible to achieve more effective scattering by forming PDLC such that when light from the projector 3 is projected onto the PDLC panel 10 in the form of a planar projection, the liquid crystal droplets are arranged in a direction perpendicular to a direction in which the light projected by the projector 3 enters the PDLC panel 10. In the case where the PDLC panel 10 includes reverse mode PDLC, it is more effective in the case where liquid crystal molecules in the liquid crystal droplets each have a major axis that is perpendicular to the above direction in which the light projected by the projector 3 enters the PDLC panel 10.

The following describes, in relation to a preferred mode of the PDLC, a method for arranging liquid crystal droplets as described above.

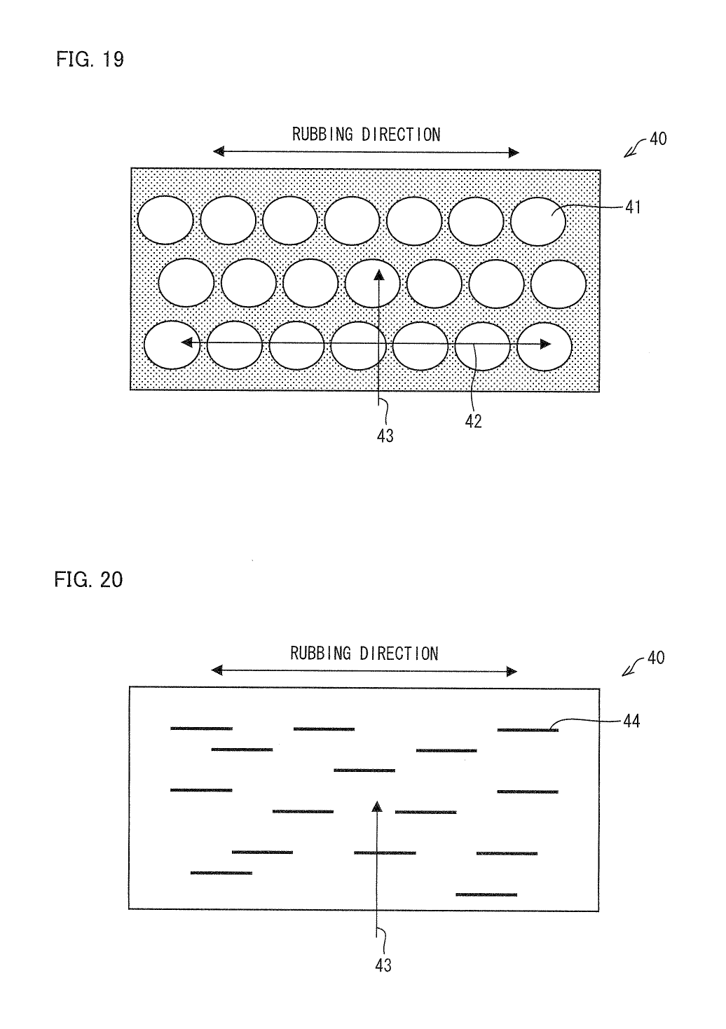

FIG. 19 is a cross-sectional view illustrating a direction in which liquid crystal droplets 41 in the PDLC layer 40 having the normal mode are arranged. FIG. 20 is a cross-sectional view illustrating a direction in which liquid crystal droplets 41 in the PDLC layer 40 having the reverse mode are arranged.

PDLC does not necessarily require a polarizing plate or an alignment plate. Thus, the substrates 20 and 30 may or may not be each provided, on a surface facing the PDLC layer 40, with an alignment film formed of (i) an organic film such as a polyimide film or (ii) an inorganic film.

In the case where the substrates 20 and 30 are each not subjected to an alignment process such as rubbing and optical alignment, liquid crystal droplets in the PDLC after UV exposure (that is, a region having a high liquid crystal density as a result of phase separation due to UV polymerization) are formed randomly along the substrate surface.

When the PDLC panel 10 is in a light scattering state, light incident in a normal line direction of the PDLC panel 10 (that is, a panel normal line direction) is scattered to generate a scattered component having an intensity that is, although slightly subject to influence by the wires, basically isotropic with respect to the panel normal line direction.

However, in the case where (i) the substrates 20 and 30 are each subjected, on the surface facing the PDLC layer 40, to an alignment process such as rubbing so that the substrates 20 and 30 have their respective rubbing directions that are parallel or antiparallel to each other, and (ii) an optimal PDLC material and optimal UV exposure conditions are selected, it is possible to position (arrange) the liquid crystal droplets 41 along the rubbing direction, that is, parallel to the substrate surface, as illustrated in FIG. 19.

The substrates 20 and 30 may be subjected to a surface treatment (alignment process) by a method other than rubbing. The surface treatment may involve, for example, cutting fine grooves.

When the PDLC panel 10 including the PDLC layer 40 illustrated in FIG. 19 is in the light scattering state, light incident in the panel normal line direction is scattered to generate a scattered component having a great intensity in a direction perpendicular, with respect to the panel normal line direction, to the direction 42 in which the liquid crystal droplets 41 are arranged.

Thus, in the case where the PDLC panel 10 is a PDLC panel including liquid crystal droplets 41 arranged as illustrated in FIG. 19, the projector 3 is preferably placed such that when light from the projector 3 is projected onto the PDLC panel 10 in the form of a planar projection, such light projected by the projector 3 enters the PDLC panel 10 in a direction 43 that is perpendicular to the direction 42 in which the liquid crystal droplets 41 are arranged. This arrangement makes it possible to (i) more effectively scatter light incident onto the PDLC panel 10 from the projector 3 and thus (ii) cause the scattered light to reach the observer.

In the reverse mode, on the other hand, in the case where the substrates 20 and 30 have their respective rubbing directions that are parallel or antiparallel (parallel and in an opposite direction) to each other, liquid crystal molecules in the liquid crystal droplets 41 (see FIG. 19) are aligned such that respective major axes 44 of the liquid crystal molecules are parallel to the rubbing direction as illustrated in FIG. 20.

When the PDLC panel 10 including the PDLC layer 40 illustrated in FIG. 20 is in the light scattering state, light incident in the panel normal line direction is scattered to generate a scattered component having a great intensity in a direction perpendicular, with respect to the panel normal line direction, to respective major axes 44 (that is, a major axis direction) of the liquid crystal molecules.

Thus, in the case where the PDLC panel 10 is a PDLC panel including liquid crystal droplets 41 that include liquid crystal molecules arranged to have their respective major axes 44 parallel to the rubbing direction as illustrated in FIG. 20, the projector 3 is preferably placed such that when light from the projector 3 is projected onto the PDLC panel 10 in the form of a planar projection, such light projected by the projector 3 enters the PDLC panel 10 in a direction 43 that is perpendicular to respective major axes 44 of the liquid crystal molecules. This arrangement makes it possible to (i) more effectively scatter light incident onto the PDLC panel 10 from the projector 3 and thus (ii) cause the scattered light to reach the observer.

### Example

The following describes results of actually producing the display system 1 including the above PDLC panel 10 and making various measurements. The description below specifies materials and production conditions as an example used in an experiment for explaining the advantages of the present invention. The present invention is thus not limited by the materials and the production conditions below.

First, a mixture of a polymerizable monomer, a photopolymerization initiator, and positive liquid crystal was injected between substrates 20 and 30 by one drop filling.

The polymerizable monomer was an ultraviolet curing diacrylate. The photopolymerization initiator was “IRGACURE651” (product name; manufactured by Ciba Pharmaceutical Company). The positive liquid crystal was “TL213” (product name; manufactured by Merck Ltd.). The polymerizable monomer, the photopolymerization initiator, and the positive liquid crystal were contained in the mixture in amounts of 20%, 0.5%, and 79.5%, respectively.

The substrates 20 and 30 included their respective transparent substrates 21 and 31 each made of glass having a relative refractive index n of 1.5.

The substrate 20, which was a TFT substrate, (i) included pixels 11 each of which was not divided and was thus in a square shape as illustrated in FIG. 2, and (ii) had an aperture ratio of 80%. The substrate 30, which was a counter substrate, had a black matrix 32 in a portion that faced wires in the substrate 20. Neither of the substrates 20 and 30 had a CF.

The cell thickness was secured at 5 μm with use of a PS (photo spacer).

Next, the mixture injected between the substrates 20 and 30 was photopolymerized, on a plate having a temperature set at 30° C., by irradiation, through a filter for blocking light having wavelengths of 340 nm and below, of UV light that had an illuminance of 50 mW/cm² at a wavelength of 365 nm. This produced a PDLC panel 10. The mixture had a liquid crystal phase-isotropic phase transition temperature (Tₙᵢ) of 22° C.

Neither of the substrates 20 and 30 was subjected to an alignment process such as rubbing and an optical alignment. The PDLC panel 10 included, in its PDLC, liquid crystal droplets 41 randomly formed along a substrate surface. The PDLC panel 10 was provided, on each of its opposite surfaces, with an anti-reflection film 14 having a moth eye structure.

Measurements were made, with use of LCD evaluating device “LCD-5200” (product name) manufactured by Otsuka Electronics Ltd., of transmittance along a panel normal line direction of the PDLC panel 10 produced as above. The measurements showed a transmittance of 3% in a light scattering state and a transmittance of 63% in a light transmitting state.

The PDLC panel 10, serving as a display section (screen section), was set up in such a manner that the substrate 30 including the black matrix 32 was on an observer side. A projector 3 was set up above the PDLC panel 10 on a side of the substrate 20 serving as a back substrate.

Alignment between the projector 3 and the PDLC panel 10 was carried out manually. The projector 3 and the PDLC panel 10 were connected as illustrated in the block diagram of FIG. 9. Further, an audio output section (not shown) was connected to the arithmetic operation control section 53 and the feedback circuit 64 both illustrated in FIG. 10.

Then, as described above, the data receiving section 51 received, from an external device as a video signal, (i) image data including a mixture of a character and text and (ii) audio data. The arithmetic operation control section 53 created an image to be displayed on the PDLC panel 10, and transmitted the image to the video image control section 54. The video image control section 54 then converted the image transmitted by the arithmetic operation control section 53 into (i) an image to be displayed on the PDLC panel 10 and (ii) an image to be outputted by the projector 3, and transmitted the images to the PDLC panel 10 and the projector 3, respectively.

The image transmitted to the PDLC panel 10 (that is, the image to be displayed on the PDLC panel 10) was an image formed as if by filling up an image of the character and text included in the image to be outputted by the projector 3.

Next, the video image control section 54 in FIG. 10 caused the image of the PDLC panel 10 and the image of the projector 3 to be displayed in synchronization with each other. This caused the PDLC panel 10 to (i) display, only in a scattering portion 13, an image as illuminated by light from the projector 3 placed behind the PDLC panel 10 and (ii) achieve, in a transparent portion 12, a transparent state (see-through state) having high panel transmittance since there is no CF. As such, it was possible to carry out, in synchronization with a sound, a display in which an image looked as if it had popped up in the air against the background on a back side of the panel.

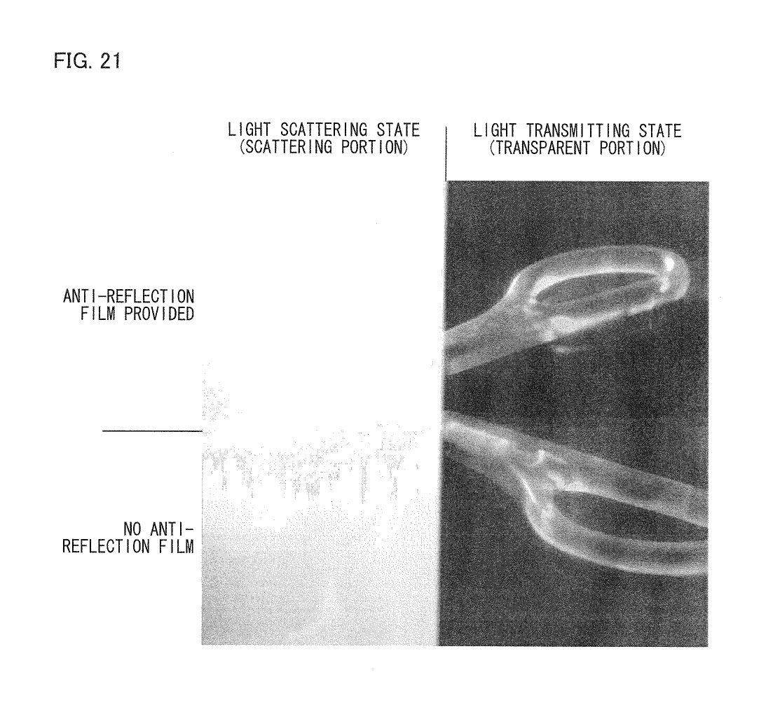

The following describes, with reference to FIG. 21, results of conducting a demonstrative experiment on the effect of the anti-reflection film 14.

FIG. 21 illustrates results of capturing a display image of a PDLC panel 10 including a combination of (i) a commonly used TFT substrate that had pixels each divided into three regions of R, G, and B and that had an aperture ratio of 55% and (ii) a counter substrate including only a black matrix. The display image was obtained by (i) providing the anti-reflection film 14 to only the upper half of each of opposite surfaces of the PDLC panel 10, (ii) setting the left half of the display screen to a light scattering state (scattering portion) and the right half of the display screen to a light transmitting state (transparent portion), and (iii) irradiating the PDLC panel 10 with white light so that the left half of the display screen carried out a light-scattered display and that the right half of the display screen carried out a light-transmitting display.

This experiment placed a black acrylic plate on a back surface side of the PDLC panel 10 as viewed from the observer, placed scissors on the acrylic plate, irradiated the PDLC panel 10 with white light from the back surface side of the PDLC panel 10 as viewed from the observer, and thus compared respective displays carried out, in the scattering portion, by (i) a portion to which the anti-reflection film 14 was provided and (ii) a portion to which no anti-reflection film 14 was provided. The anti-reflection film 14 was a moth eye (that is, an anti-reflection film having a moth eye structure).

The results indicate that the upper half of the PDLC panel 10, to which upper half the anti-reflection film 14 was provided, showed no visible external light in the transparent portion, and the handle of the scissors was visible. This caused the scattering portion to look as if it had popped up.

The results indicate that the lower half of the PDLC panel 10, to which lower half no anti-reflection film 14 was provided, showed visible external light reflection in the transparent portion in front of the scissors as viewed from the observer. This ruined the display in which an image had popped up in the air.

The provision of the anti-reflection film 14 increased the brightness of the scattering portion. This was because (i) since the substrates 20 and 30 (that is, the front substrate and the back substrate) each had reduced surface reflection, a larger amount of light reached the PDLC layer 40, and (ii) a larger amount of scattered light was extracted instead of being internally reflected.

The following describes (i) the effect of the anti-reflection film 14 and (ii) an effect achieved by providing, in front of the wires as viewed from the observer, a member for reduction of direct reflection by the wires. The description below refers to results of comparison between (i) a case involving the use of the anti-reflection film 14 and the above member and (ii) a case involving no such use.

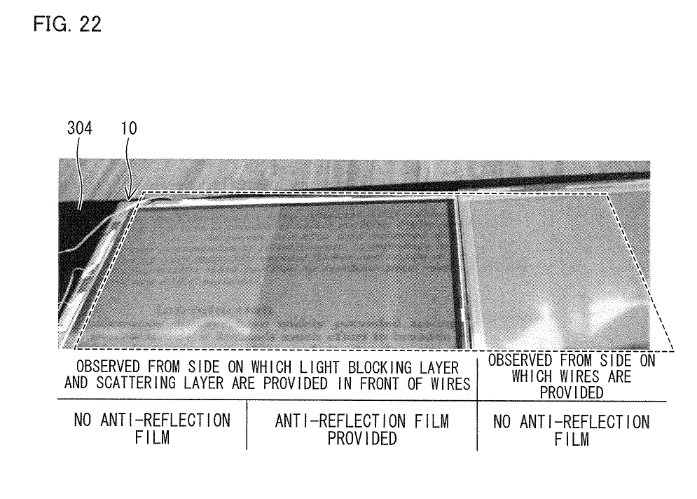

FIG. 22 illustrates results of capturing images of a display screen of the PDLC panel 10, the images having been obtained by observing, from (i) a side of the wires and from (ii) a side of the black matrix 32 (light blocking layer) and the PDLC layer 40 (light scattering layer) both provided in front of the wires, the PDLC panel 10 both when it is provided with the anti-reflection film 14 and when it is provided with no anti-reflection film 14.

This experiment (i) placed the PDLC panel 10 on a black curtain 304 and a white board (not shown) in a regular reflection direction, (ii) set, as a scattering portion, the inside of a region indicated by a dotted line in FIG. 22, and (iii) caused the projector 3 to display, from a front surface side of the PDLC panel 10 as viewed from the observer, text in the inside of the region indicated by the dotted line.

The PDLC panel 10 included a black matrix 32, as a light blocking layer, provided (i) in the substrate 30 facing the substrate 20 including the wires and (ii) at a position facing the source wires 24 and the gate wires 25. The PDLC panel 10 included no light blocking layer at a position facing the Cs wires 26. Thus, when the PDLC panel 10 was observed from the side of the substrate 30 including the black matrix 32, the PDLC layer 40 was visible with no light blocking since it was in front of the Cs wires 26.

FIG. 22 illustrates, in its right portion, a display state for the case in which the PDLC panel 10 provided with no anti-reflection film 14 was observed from the side of the wires (that is, from the side of the substrate 20 including the wires).

FIG. 22 illustrates, in its left and central portions, respective display states for (i) a case in which the PDLC panel 10 was provided with no anti-reflection film 14 and (ii) a case in which the PDLC panel 10 was provided with the anti-reflection film 14. In each of the above cases, the PDLC panel 10 was observed from the side of (i) the black matrix 32 as a light blocking layer and (ii) the PDLC layer 40 as a light scattering layer (that is, from the side of the substrate 30 including the black matrix 32) both provided in front of the wires.

As is clear from FIG. 22, in the case where the PDLC panel 10 was observed from the side of the wires, that is, in the case where the PDLC panel 10 was not provided with the anti-reflection film 14 and also was not provided with the black matrix 32 as a light blocking layer or the PDLC layer 40 as a light scattering layer both in front of the wires as viewed from the observer (that is, from the display surface side), the text was illegible since the white board had intense whiteness due to direct reflection by the wires.

On the other hand, in the case where the PDLC panel 10 was observed from the side of the black matrix 32 as a light blocking layer and the PDLC layer 40 as a light scattering layer both provided in front of the wires, the text was slightly legible at a portion with no anti-reflection film 14.

One reason for the above observation is that providing, as described above, a light blocking film in front of the wires as viewed from the observer eliminates influence of visibility of whiteness of the white board, the visibility arising from direct reflection by the wires. Such visibility of whiteness of the white board due to direct reflection by the wires was eliminated also in a case where a light-transmitting display was carried out.

Light passed through the PDLC layer 40 and was then reflected by the Cs wires 26. Thus, light from the projector 3 serving as a light source device 4 was highly dispersed, and the viewing angle was widened. These effects made it possible to create, even at a portion with no anti-reflection film 14, a video image that looked as if it had popped up in the air.

In the case where the PDLC panel 10 was observed from the side of the black matrix 32 as a light blocking layer and the PDLC layer 40 as a light scattering layer both provided in front of the wires, the text was more legible at a portion with the anti-reflection film 14.

A reason for this is that the anti-reflection film 14 reduced visibility of whiteness of the white board, the visibility arising from regular reflection at the substrate interface. Such visibility of whiteness of the white board due to regular reflection at the substrate interface was eliminated also in a case where a light-transmitting display was carried out. This made it possible to create, at a portion with the anti-reflection film 14, a video image that more clearly looked as if it had popped up in the air.

[Variation]

The following describes variations of the constituent members of the display system 1.

The description below first mainly deals with variations of the light source device 4.

The projector 3 used in the present embodiment can be any of various projectors that have been publicly known. The projector 3 is thus not particularly limited, and a suitable example thereof is a focus-free projector such as a laser projector as mentioned above.

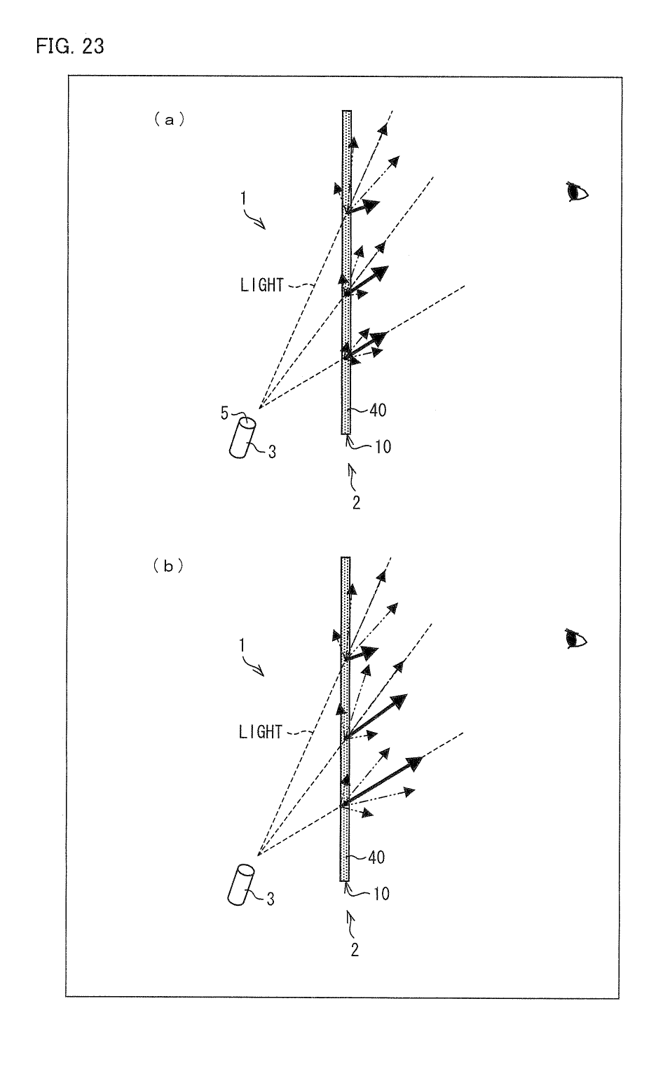

The light source device 4 (see (a) and (b) of FIG. 5) such as the projector 3 preferably has a lens that is provided, as illustrated in (a) of FIG. 23, with a member such as a filter (optical member), e.g., an ND filter 5, that has a gray scale which is continuously varied. The description below deals with the projector 3 as an example of the light source device 4.

(a) and (b) of FIG. 23 are each a cross-sectional view illustrating an effect of the ND filter 5. (a) of FIG. 23 illustrates how a light-scattered display is carried out on the surface of a PDLC panel 10 in a display system 1 including the ND filter 5 for the projector 3 as the light source device 4. (b) of FIG. 23 illustrates how a light-scattered display is carried out on the surface of a PDLC panel 10 for a case in which the display system 1 illustrated in (a) of FIG. 23 includes no ND filter 5.

(a) and (b) of FIG. 23 illustrates, to indicate light scattering on the surface of the PDLC panel 10, chain double-dashed lines and solid lines, out of which the solid lines indicate the intensity of light visible to the observer.

As illustrated in (b) of FIG. 23, in a case where the projector 3 is provided behind the PDLC panel 10 to face a lower portion thereof, a display carried out on the PDLC panel 10 with use of light projected by the projector 3 is (i) bright in an area corresponding to a lower portion of the PDLC panel 10 in which area the observer, a display portion of the PDLC panel 10, and the projector 3 are positioned in a straight line and (ii) darker at a portion located farther upward.

The above problem can be solved by, as illustrated in (a) of FIG. 23, providing the projector 3 with an ND filter 5 that renders transmittance low at a lower portion and higher at a portion located farther upward. This makes it possible to carry out a uniform display with even brightness.

Such compensation by the ND filter 5 may further be carried out in a lateral direction as well.

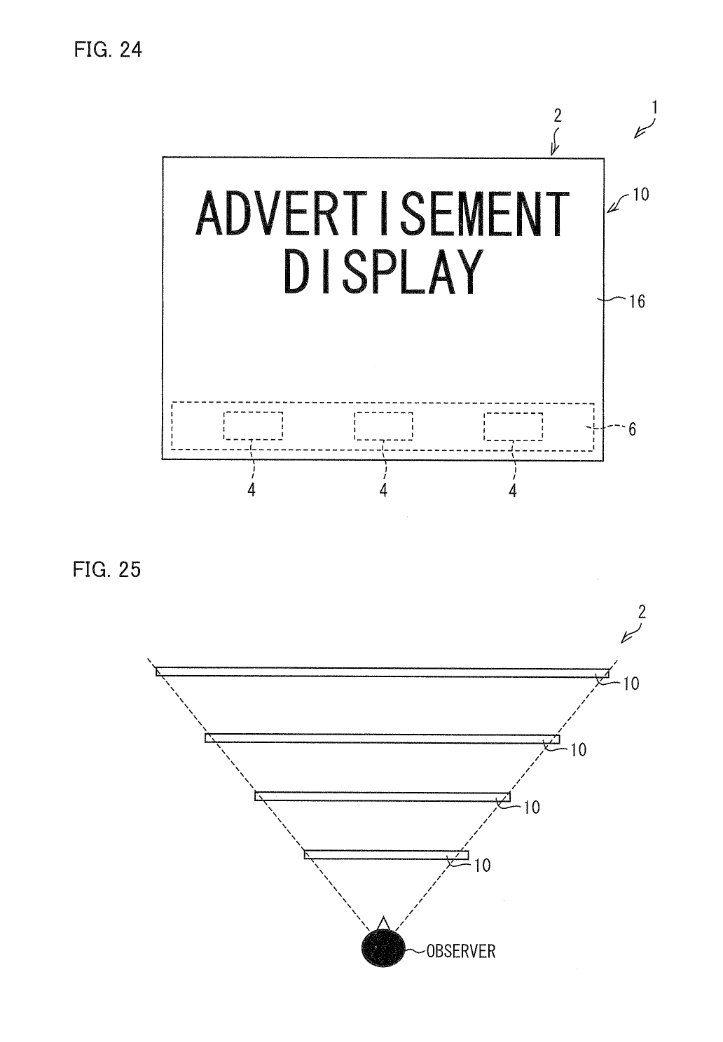

FIG. 24 is an elevational view schematically illustrating a configuration of a display system 1, as viewed from a front surface side of a PDLC panel 10, which display system 1 includes a plurality of light source devices 4.

FIG. 24 illustrates an example case involving light source devices 4 placed on a back surface side of the PDLC panel 10 as viewed from the observer. How to place the light source devices 4 is, as described above, not limited to this.

As illustrated in FIG. 24, there may be provided a plurality of light source devices 4. In other words, the display system 1 may include a plurality of light source devices 4.

In such a case, the light source devices 4 may be, for example, projectors 3 for displaying a video image which projectors 3 include three projectors, namely a projector for projecting red (R) light, a projector for projecting green (G) light, and a projector for projecting blue (B) light.

Further, in the case where the light source devices 4 do not emit light to display a single video image together, but individually irradiate their respective partial areas in the display area 16 of the PDLC panel 10, the projectors 3 including three projectors for R, G, and B as described above can carry out a colorful display having different colors for the respective areas (that is, the respective areas irradiated by the individual light source devices 4). In this case, it is further possible to, for example, display a yellow (Y) area at a portion where red light overlaps green light.

In the above case also, providing, for example, light source devices 4 for the respective colors of R, G, and B as described above makes it possible to carry out a colorful display having different colors for the respective areas irradiated by the individual light source devices 4.

In the case where a plurality of light source devices 4 are provided to irradiate their respective partial areas in the display area 16 of the PDLC panel 10 as described above, the light source devices 4 can emit light to either the entire display area 16 of the PDLC panel 10 or a plurality of partial areas in the display area 16.

In the case where the light source devices 4 are, for example, a plurality of LEDs as described above, the light source devices 4 as a plurality of LEDs may, for example, be mounted on a circuit board 6 as illustrated in FIG. 24.

As described above, the light source devices 4 may each be, for example, not a projector that projects an image (video image) in the form of multicolor light by projecting an enlarged image with use of, for example, a CRT (cathode ray tube) or liquid crystal, but a light source device that is, for example, simply configured to only carry out an ON/OFF control (turning on/off) for monochrome or multicolor light as described above.

The display system 1 may be arranged to display, as its image, a video image such as a moving image. Alternatively, the display system 1 may be arranged to display a still image such as text by (i) using an LED, a monochrome laser projector, an overhead projector, a slide projector or the like as the light source device 4 and (ii) providing a scattering portion 13 at a predetermined position in a predetermined shape as described above. With such an arrangement, causing the light source device 4 to emit monochrome or multicolor light to, for example, the scattering portion 13 in the shape of text as illustrated in FIG. 24 makes it possible to carry out a display in which colored text looks as if it has popped up from a colored background having high transparency.

In the case where the scattering portion 13 is provided at a predetermined position in a predetermined shape as described above to display, for example, (i) a still image such as text or (ii) a time, a date or the like, it is not necessary to carry out an active matrix drive for the PDLC panel 10. In this case, it is possible to carry out a display by turning on or off, for example, (i) segmented electrodes provided to the PDLC panel 10 as a voltage applying means (electric field applying means) or (ii) electrodes provided to the PDLC panel 10 and each having a predetermined shape in correspondence with the shape of an image to be displayed.

As described above, there is no particular limit to how to drive the PDLC panel 10 and the display device 2. It is thus possible to use any of various driving methods depending on the method of carrying out a display.

Thus, in terms of the driving method, the PDLC panel 10 and the display device 2 can be, for example, (i) an active matrix display panel and an active matrix display device based on the active matrix system or (ii) a simple matrix display panel and a simple matrix display device based on the simple matrix system. To carry out a desired display with high resolution, however, it is preferable to use an active matrix display panel and an active matrix display device.

In the case where the above light source device 4 is, for example, a laser projector, the light source device 4 can simply emit video image light to the PDLC panel 10. However, in the case where the light source device 4 is an LED projector including an LED as a light source (light outputting section) of the projector, it is preferable to provide, to the light outputting section of the projector, a lens corrected so that a video image displayed on the PDLC panel 10 is not distorted.

The following mainly describes variations of the display device 2.

FIG. 25 is a bird's eye view illustrating a display device 2 including a plurality of PDLC panels 10.

As illustrated in FIG. 25, the display device 2 may include a plurality of PDLC panels 10.

In the case illustrated in FIG. 25, the PDLC panels 10 are arranged in a depth direction as viewed from the observer. This makes it possible to provide a three-dimensional expression utilizing the depth. In the case where a PDLC panel 10 placed farther away from the observer in the depth direction is larger as illustrated in FIG. 25, it is possible to achieve a more natural sense of depth.

Further, in the case where a PDLC panel 10 placed farther away from the observer in the depth direction is larger such that, as viewed from the observer, both (i) the sides of left side sections of the respective PDLC panels 10 are positioned in a straight line and (ii) the sides of right side sections of the respective PDLC panels 10 are positioned in a straight line (see FIG. 25), it is possible to achieve an even more natural sense of depth. In other words, in the case where there are provided a plurality of PDLC panels 10, the PDLC panels 10 are preferably arranged and sized such that, as viewed from the observer, both (i) the sides of the left side sections of the respective PDLC panels 10 are positioned in a straight line and (ii) the sides of the right side sections of the respective PDLC panels 10 are positioned in a straight line.

In the case where there are arranged a plurality of PDLC panels 10 as described above, a light source device 4 may be provided for each PDLC panel 10. Alternatively, in the case where the light source device 4 is a focus-free light source device such as a laser projector or in the case where the light source device 4 is a monochrome light source device for emitting monochromatic light to the entire display area 16 of a PDLC panel 10, there may be provided a fewer number of light source devices 4 than the number of the PDLC panels 10.

In the case where there are provided a fewer number of light source devices 4 than the number of the PDLC panels 10 as described above, controlling a scattering portion of each PDLC panel 10 corresponding to a single light source device 4 allows a display providing a sense of depth to be carried out with use of such a single light source device 4.

In this case, the PDLC panels 10 form their respective scattering portions 13 (i) each in a shape formed as if by filling up a portion of an image (for example, one of a plurality of characters) to be projected by the light source device 4 and (ii) in regions in the respective display areas 16 which regions are different from one another such that the respective scattering portions 13 of the PDLC panels 10 do not overlap one another. This allows the image projected by the light source device 4 to be displayed by the PDLC panels 10 as divided among the PDLC panels 10. In other words, in the case where, for example, four characters are displayed individually by respective four different PDLC panels 10 (that is, one character for each PDLC panel 10) arranged in front and back of one another so as to overlap one another, the four characters can have perspective with respect to one another. This makes it possible to carry out a clear display that provides a sense of depth and a greater sense of three dimensionality.

In the case where a voltage applied to each electrode in the PDLC panels 10 is controlled so that the degree of scattering is adjusted and that a plurality of PDLC panels 10 form their respective scattering portions 13 that are positioned in a straight line, the PDLC panels 10 can display video images that are identical to one another and that are positioned along the depth direction.

The above PDLC panel 10 may have a flat panel surface or a curved panel surface.

In the case where the respective transparent substrates 21 and 31 of the substrates 20 and 30 are plastic substrates or metal substrates, it is possible to curve the panel surface of the PDLC panel 10 relatively easily.

Even in the case where the transparent substrates 21 and 31 of the PDLC panel 10 are glass substrates, it is possible to curve the panel surface by setting the glass thickness to, for example, approximately 100 μm.

In the case where the panel surface is curved so as to have a convexity toward the observer, it is possible to improve expressive power with respect to observation at various angles. Further, in the case where the panel surface is curved so as to have a convexity toward the observer, it is possible to carry out a display that provides a great sense of presence.

[Electronic Device]

The following describes (i) applications of the PDLC panel 10 or the display system 1 that includes the display device 2 including the PDLC panel 10 and (ii) an example electronic device including the PDLC panel 10 or the display system 1.

As described above, the present embodiment uses a projector 3 to express colors for a color display. The PDLC panel 10 thus needs no CF, and consequently has high transmittance.

In the case where the light source device 4 is a projector 3 as described above so that a high-resolution display is carried out in a projector mode, the PDLC panel 10 can decrease the resolution. This allows the PDLC panel 10 to have higher transmittance. Thus, when a scattering/transparent display (light scattering/light transmitting display) is to be carried out, it is possible to carry out a transparent display having high transparency.

As described above, when a color display is carried out, the PDLC panel 10 is strong in forward-scattering and can thus carry out a sharp display, but is weak in back scattering. Thus, in the case where the projector 3 as a light source device is placed behind the PDLC panel 10 as viewed from the observer, the PDLC panel 10 displays on its back surface a dark, inverted video image. Such a display is thus difficult for any person other than the observer to recognize.

The PDLC panel 10 can thus find an application in which a display as viewed from behind is desirably difficult for any person other than the observer to recognize. The PDLC panel 10 can, for example, be suitably used in a mobile telephone or an electronic dictionary.

In the case where the display system 1 is used for an electronic dictionary or the like, the display system 1 is simply required to be set to the projector mode only when a picture or photograph is displayed. In the case where the display system 1 is set to the projector mode when a picture or photograph is displayed as described above, it is possible to carry out a display excellent in design. On the other hand, in the case where the display system 1 displays text or the like and requires no color display, power consumption can be reduced by driving only the PDLC panel 10 so that (i) a monochrome light scattering/light transmitting display is carried out and that (ii) the output of the projector 3 is turned off.

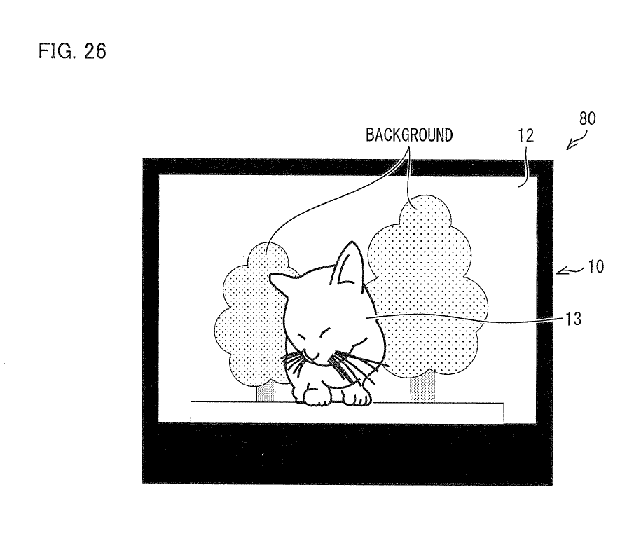

In the case where the PDLC panel 10 or the display system 1 including the PDLC panel 10 is used for an electronic picture frame 80 as illustrated in FIG. 26, such an electronic picture frame 80 shows a scattering portion 13 that looks as if it has popped up in the air, and can thus be a unique artwork item that cannot be produced by a paper picture. The electronic picture frame 80 can also be used as a portable terminal.

As described above, a video image projected by the projector 3 can be shaped in any manner by, for example, randomly changing the respective shapes of the transparent portion 12 and the scattering portion 13. Further, the video image can be combined with the background for various unique displays.

Thus, in the case where, for example, the display system 1 is used as illustrated in FIG. 7, by, for example, (i) placing the PDLC panel 10 behind a display window, (ii) placing a commodity or the like such as actual shoes 303 behind the PDLC panel 10 so that a light-transmitting display is carried out as illustrated in FIG. 7, and (iii) causing a scattering portion to display an image (projector video image) such as: a captured image related to the commodity; or animation, it is possible to effectively advertise an image, application, use method or the like of the commodity through the sense of vision.

Further, in the case where, as illustrated in FIG. 8, (i) the PDLC panel 10 has a scattering portion 13 inside a transparent portion 12 and (ii) for example, a captured image is displayed in the scattering portion 13 as a projector video image, it is possible to display an impactful video image in which the projector video image looks as if it has popped up.

In the case where the PDLC panel 10 is provided in a space including a background such as a partition plate or windowpane, it is possible to carry out a more impactful display. Using the PDLC panel 10 as, for example, a freestanding signboard also achieves an excellent eye-catching effect.

The display system 1 can thus be suitably used as a display system that is capable of a color display and that is used for greatly eye-catching digital signage.

The display system 1 can further be suitably used for a theater system, a display for office use, a videoconference system and the like.

The PDLC panel 10 may be provided so that it can be observed from either of its opposite sides.

The PDLC panel 10 can be combined with a compact projector 3 as the light source device 4 so as to be suitably used for, e.g., a portable terminal such as a mobile telephone.

### Embodiment 2

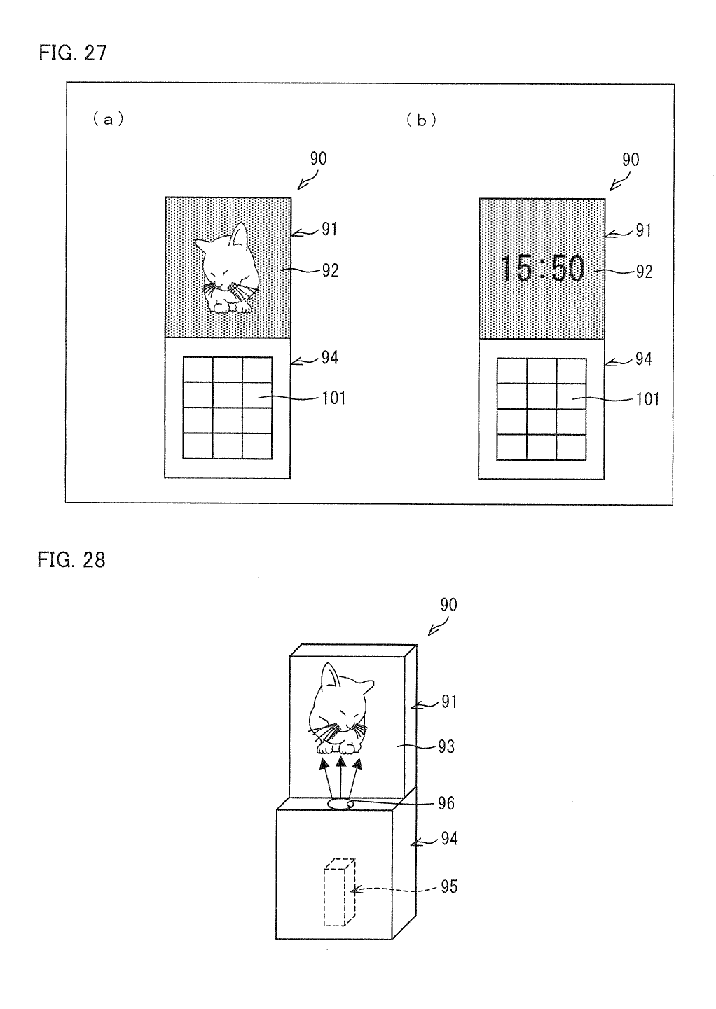

The following description deals with a second embodiment of the present invention with reference to (a) and (b) of FIG. 27 through FIG. 29.

For convenience of explanation, members having like functions described in Embodiment 1 with reference to the above drawings are given like reference numerals, and are not described here.

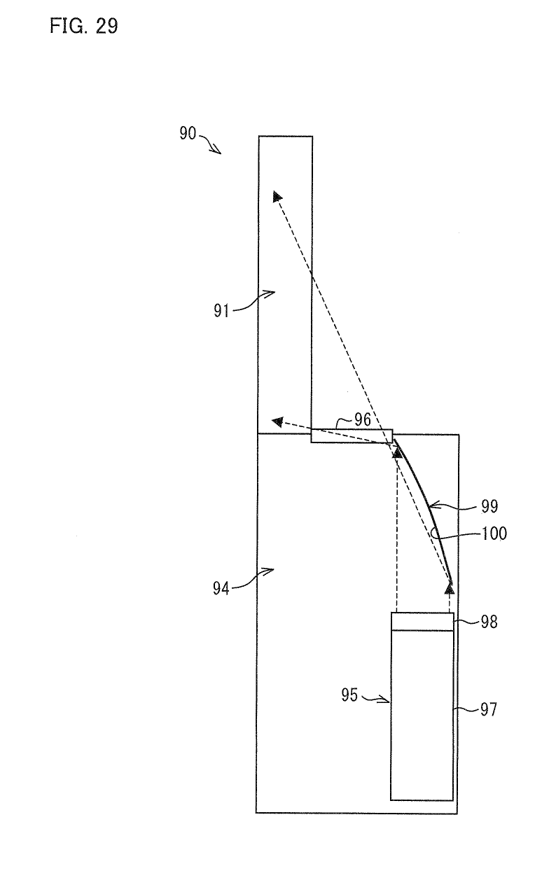

The present embodiment below describes, with reference to (a) and (b) of FIG. 27 and FIG. 28, an example in which the display system 1 of Embodiment 1 is used for a portable terminal such as a mobile telephone.

The present embodiment describes an example in which the display system 1 is used for a mobile telephone as an example of a portable terminal.

(a) and (b) of FIG. 27 are each an elevational view schematically illustrating a configuration of a mobile telephone of the present embodiment. FIG. 28 is a rear perspective view schematically illustrating a configuration of the mobile telephone illustrated in FIG. 27.

The mobile telephone 90 of the present embodiment, as illustrated in (a) and (b) of FIG. 27, includes: a display section 91 for causing a display surface 92 to display, as illustrated in (a) and (b) of FIG. 27 and FIG. 28, a video image to be viewed by a user, such as an image, a time, and a telephone number; and a device body 94 including operation keys 101 (operation section) for accepting an operation for causing the mobile telephone 90 to function as a telephone and an operation for causing the display section 91 to display a video image.

The display section 91 includes, as a display device and a display panel respectively, the display device 2 and the PDLC panel 10 both described in Embodiment 1. The device body 94 includes a compact projector 95 as a light source device (that is, the light source device 4 illustrated in, for example, (a) and (b) of FIG. 5) for emitting light to a back surface 93 of the display section 91 as illustrated in FIG. 28.

Specifically, the mobile telephone 90 is arranged such that the compact projector 95 is contained in the device body 94 and outputs light (video image) to the back surface 93 of the display section 91 from a position that is (i) near the display panel of the display section 91 and (ii) behind the display section 91.

The device body 94 of the mobile telephone 90 contains a lens (for example, an aspheric concave surface reflecting mirror) corrected so that a video image with no distortion is displayed from an opening window 96 onto the back surface 93 of the display panel (that is, the PDLC panel 10) included in the display section 91.

The following describes video image irradiation by the compact projector 95 to the display section 91 with reference to FIG. 29.

FIG. 29 is a cross-sectional view schematically illustrating a configuration of the mobile telephone 90 illustrated in (a) and (b) of FIG. 27 and FIG. 28.

The compact projector 95, as illustrated in FIG. 29, includes: a video image outputting section 97 for outputting a video image formed by a light modulation section; and a projection lens 98 for enlarging a video image outputted by the video image outputting section 97.

The light modulation section in the compact projector 95 is, for example, (i) a light modulation section including a laser or (ii) a light modulation section including a DMD (digital micro-mirror device; registered trademark) and liquid crystal.

FIG. 29 indicates, by arrows with dotted lines, light projected from the projection lens 98 of the compact projector 95.

Specifically, the video image outputting section 97 of the compact projector 95 projects light, which is (i) reflected by a reflecting surface 100 of an aspheric concave surface reflecting mirror 99 contained in the device body 94, (ii) passed through the opening window 96 provided in an upper surface of the device body 94, and (ii) projected onto the back surface 93 of the display section 91. The arrows with dotted lines in FIG. 29 indicate projected light in a simplified manner for convenience of explanation, and thus do not strictly indicate, for example, light occurring before image formation.

In the case where a color display is carried out by the mobile telephone 90, it is simply necessary to synchronize respective video images of the display section 91 and the compact projector 95 by the method described in Embodiment 1.

The mobile telephone 90 uses the compact projector 95 to express colors for a color display. This allows the PDLC panel 10 constituting the display section 91 to have higher transmittance.

Carrying out a high-resolution display with use of the compact projector 95 allows the PDLC panel 10 constituting the display section 91 to have low resolution. This arrangement further increases the transmittance of the PDLC panel 10. With this arrangement, the mobile telephone 90 can also carry out a transparent display with high transparency when a scattering/transparent display is carried out.

In the case where a monochrome scattering/transparent display is carried out by the display section 91, the compact projector 95 in the device body 94 does not output light, and instead a voltage is applied to the PDLC panel 10 to form a transparent portion 12 and a scattering portion 13 so that an image display (light-scattered display) can simply be carried out by the scattering portion 13. This arrangement reduces power consumed for an output by the compact projector 95, and thus allows a display to be carried out with low power consumption.

In the case where the PDLC panel 10 is used as the display section 91 to carry out a color display as described above, the PDLC panel 10 is, as described above, (i) strong in forward-scattering and can thus carry out a sharp display on the display surface 92 of the display section 91, but (ii) weak in back scattering and thus displays a dark, inverted video image on the back surface 93 of the display section 91. The mobile telephone 90 consequently carries out a display that is difficult to be recognized by a person other than the observer which person views the display from the back surface 93 side.

A compact device such as the mobile telephone 90 can have improved design by curving a panel surface thereof.

### Embodiment 3

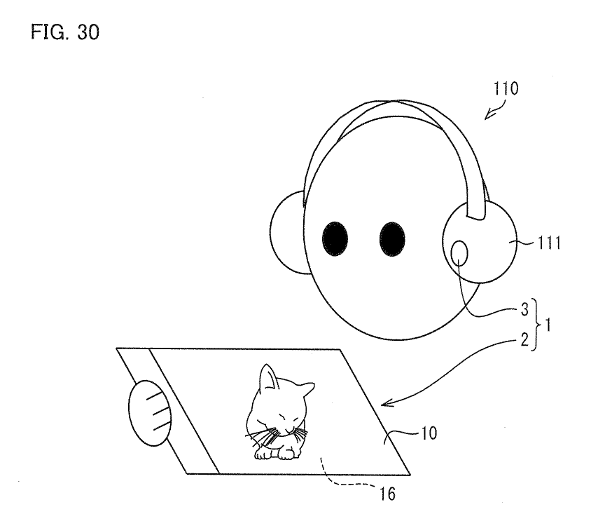

The following description deals with a third embodiment of the present invention with reference to FIG. 30. For convenience of explanation, members having like functions described in Embodiments 1 and 2 with reference to the above drawings are given like reference numerals, and are not described here.

Embodiments 1 and 2 above mainly deal with, as an electronic device including the display system 1 of the present invention (particularly a hand-held electronic device or a portable electronic device), the electronic picture frame 80, the mobile telephone 90, and an electronic device, such as an electronic dictionary, which incorporates the display device 2 (the PDLC panel 10) and the projector 3 in a single device.

The present embodiment describes, with reference to FIG. 30, the display system 1 as a hand-held electronic device and as an electronic device of a separate type, which includes the PDLC panel 10 and the projector 3 as separate members.

FIG. 30 is a diagram schematically illustrating an example electronic device including the display system of the present embodiment.

The electronic device of the present embodiment includes, as separate devices independent of each other, (i) the display device 2 including the PDLC panel 10 and (ii) the projector 3. The electronic device is an example including headphones 110 (device; portable terminal; electronic device) that include a loud speaker section 111 including a projector 3 as the light source device 4.

The display system 1 illustrated in FIG. 30 is arranged such that (i) the display device 2 is hand-held by a user and that (ii) the projector 3 included in the loud speaker section 111 of the headphones 110 projects a video image onto the PDLC panel 10 in the display device 2.

In this case, the projector 3 included in the loud speaker section 111 of the headphones 110 may be connected to the display device 2 by either a wirelessly means or a wired means. In the case where the projector 3 is connected to the display device 2 by a wireless means, such connection may, for example, be (i) a radiowave connection such as Bluetooth (registered trademark) or (ii) an infrared radiation connection such as IrDA (registered trademark).

The projector 3 may, instead of being provided in the loud speaker section 111 of the headphones 110, be held in a state of being hung from a pair of eyeglasses (not shown) or a neck (not shown).

The projector 3 may also be provided (i) in a facility or (ii) on a computer, a desk or the like. In this case, it is necessary to place the projector 3 such that a video image is appropriately projected onto the display device 2 hand-held by the user.

In the display system 1 illustrated in FIG. 30, alignment between respective images of the display device 2 and the projector 3 can be carried out by a method identical to the method described in Embodiment 1 above.

Information on a position of the PDLC panel 10 relative to the projector 3 (that is, the light source device 4) or information on a position of the projector 3 (that is, the light source device 4) relative to the PDLC panel 10 can simply be detected by, for example, as described above in Embodiment 1 with reference to FIG. 14, (i) providing retro-reflective plates 71 outside the display area 16 of the PDLC panel 10, and providing, to the projector 3 (that is, the light source device 4), a sensor 58 including a light-receiving element and a light-emitting element, or as described above with reference to FIG. 15, (ii) providing a sensor 58 outside the display area 16 of the PDLC panel 10 and providing retro-reflective plates 71 to the projector 3 (that is, the light source device 4).

Alternatively, as described above with reference to FIG. 16, information on a position of the PDLC panel 10 relative to the projector 3 (that is, the light source device 4) may be detected by providing, inside the display area 16 of the PDLC panel 10, sensors 59 (in-pixel sensors) each including a light-receiving element.

The above position information may be detected through (i) a trigonometrical survey system or (ii) a phase difference distance-measuring involving use of a laser light source.

The above image alignment is preferably carried out before the projector 3 outputs light when a display is to be carried out through operation of the display device 2 or the projector 3. Light outputted by the projector 3 before alignment may dazzle a user or another person.

For the above electronic device of the separate type, the panel position is in most cases unfixed. The above alignment is thus preferably carried out constantly or regularly.

In the case where the display section (that is, the PDLC panel 10) is separated from the light source device 4 by a distance as described above, it is possible to (ii) cause the light source device 4 to emit light with uniform brightness to the entire display area 16 of the PDLC panel 10 without use of a complicated optical system, and also to (ii) distribute the weight burden of the devices.

The present embodiment describes an example case in which the above display medium is PDLC, in which liquid crystal in the form of droplets is dispersed in a polymer. The display medium is, however, not limited to only PDLC, provided that the display medium makes it possible to selectively form a light transmitting region and a light scattering region in response to control of the presence or absence of an electric field applied to the PDLC.

The display medium may alternatively be PNLC (polymer network liquid crystal), which includes, in a continuous phase of liquid crystal, a polymer in the form of a network, and which is switched between a light transmitting state and a light dispersing state in response to the presence or absence of an electric field applied to the PNLC.

In other words, liquid crystal droplets in the PDLC layer of the display medium may each be either (i) an independent droplet (single droplet) isolated from adjacent droplets or (ii) a continuous droplet joined with adjacent droplets.

As described above, a display panel of the present invention includes: a first substrate including a wire; a second substrate provided so as to face the first substrate; and a display medium provided between the first substrate and the second substrate, the display medium being switched between a light transmitting state and a light scattering state in correspondence with presence or absence of an electric field applied to the display medium, the display panel including no colored layer, the display panel selectively forming a light transmitting region and a light scattering region in response to control of the presence or absence of the electric field applied to the display medium, at least one of a reflectance reducing layer for reducing direct reflection of external light by the wire, a light blocking layer covering the wire, and the display medium being placed in front of the wire as viewed from an observer.

The display panel may preferably be arranged such that an anti-reflection film is provided on a surface of at least one of the first substrate and the second substrate.

As described above, a display panel of the present invention includes: a first substrate including a wire; a second substrate provided so as to face the first substrate; and a display medium provided between the first substrate and the second substrate, the display medium being switched between a light transmitting state and a light scattering state in correspondence with presence or absence of an electric field applied to the display medium, the display panel including no colored layer, the display panel selectively forming a light transmitting region and a light scattering region in response to control of the presence or absence of the electric field applied to the display medium, an anti-reflection film being provided on a surface of at least one of the first substrate and the second substrate.

According to the present invention, in the case where there is provided, as described above, at least one of (1) at least one of the reflectance reducing layer, the light blocking layer, and the display medium, each of which is placed in front of the wire as viewed from the observer, and (2) an anti-reflection film provided on a surface of at least one of the first substrate and the second substrate, it is possible to carry out a unique and impactful display in which an image in the light scattering region looks as if it has popped up in the air.

The present invention, which includes the above constituent member (1), allows prevention of direct reflection by the wire. Further, the present invention, which includes the above constituent member (2), allows prevention of substrate surface reflection. Merely including at least one of the constituent members (1) and (2) makes it possible to, as described above, carry out a display in which an image in the light scattering region looks as if it has popped up in the air. However, including both the constituent members (1) and (2) achieves a more significant advantage due to a synergistic effect thereof.

The present invention may preferably be arranged such that the first substrate is an active matrix substrate including a plurality of wires and a plurality of switching elements both provided in a matrix and; the display panel selectively forms the light transmitting region and the light scattering region in response to control, by use of the switching elements, of the presence or absence of the electric field applied to the display medium.

The above arrangement makes it possible to form a light scattering region in a desired shape, and thus carry out a desired display with high resolution.

A display system of the present invention, as described above, includes: a display device including the display panel of the present invention; and a light source device for projecting a monochrome or multicolor light beam onto the display panel.

The display system may be arranged such that the light source device projects the light beam onto only the light scattering region formed by the display panel.

The display panel displays, in the light scattering region, an image with use of light projected by the light source device.

Thus, causing the light source device to, as described above, project light onto only the light scattering region formed on the display panel makes it possible to carry out a clear, high-resolution display, and also reduce power consumption.

The display system may preferably be arranged such that the light source device projects the light beam onto the display panel from a side on which a back surface of the display panel is present.

When the above display panel is in the light scattering state, most light incident on a panel aperture is forward-scattered. Thus, to effectively use light from the light source device, it is preferable to place the light source device behind the display panel as viewed from the observer (that is, on the back surface side of the display panel). This arrangement improves efficiency in use of light from the light source device, and makes it possible to display a clear, bright image.

The display system may preferably be arranged such that the light source device projects the light beam onto the display panel at an incidence angle that is not greater than 80 degrees at a maximum.

If the angle of light incident on a farther end of the display panel from the light source device, that is, a maximum angle of light incident on the display device from the light source device, exceeds 80 degrees, the transmittance will drop abruptly, and light projected by the light source device cannot enter the display panel efficiently. In the case where the incidence angle is 80 degrees at a maximum, it is possible to achieve a transmittance of approximately 60%.

Thus, setting such a maximum incidence angle to 80 degrees or less makes it possible to carry out a display having high transmittance and even brightness.

When a polarized light component (S polarized light) parallel to an incidence surface is also taken into consideration, the transmittance does not change much with respect to the maximum incidence angle until a Brewster's angle is reached. Once the incidence angle exceeds the Brewster's angle, the reflectance drops abruptly, so that light entering the display panel from the light source device is decreased.

Thus, the display system may preferably be arranged such that the incidence angle is not greater than a Brewster's angle at the maximum.

The display system may preferably be arranged such that the display medium is polymer dispersed liquid crystal or polymer network liquid crystal each of which (i) includes a polymer and liquid crystal droplets independent of or continuous with one another and (ii) achieves the light transmitting state when the electric field is being applied to the display medium and achieves the light scattering state when no electric field is being applied to the display medium; the first substrate and the second substrate have respective surfaces each facing the display medium which surface has been subjected to an alignment process, the liquid crystal droplets being arranged along a direction of the alignment process for the first substrate and the second substrate in parallel to a substrate surface; and the light source device is placed so that in a case where the light source device projects the light beam onto the display panel in a form of a planar projection, the light beam projected by the light source device enters the display panel in a direction that is perpendicular to a direction in which the liquid crystal droplets are arranged.

When the display panel is in the light scattering state, light incident in the panel normal line direction is scattered to generate a scattered component having a great intensity in a direction perpendicular, with respect to the panel normal line direction, to a direction in which the liquid crystal droplets are arranged.

Thus, placing the light source device as described above allows light incident on the display panel from the light source device to be more effectively scattered and thus to reach the observer.

The display system may preferably be arranged such that the display medium is polymer dispersed liquid crystal or polymer network liquid crystal each of which (i) includes a polymer and liquid crystal droplets independent of or continuous with one another and (ii) achieves the light scattering state when the electric field is being applied to the display medium and achieves the light transmitting state when no electric field is being applied to the display medium; the first substrate and the second substrate have respective surfaces each facing the display medium which surface has been subjected to an alignment process, the liquid crystal droplets including liquid crystal molecules having respective major axes arranged along a direction of the alignment process for the first substrate and the second substrate in parallel to a substrate surface; and the light source device is placed so that in a case where the light source device projects the light beam onto the display panel in a form of a planar projection, the light beam projected by the light source device enters the display panel in a direction that is perpendicular to the respective major axes of the liquid crystal molecules.

When the display panel is in the light scattering state, light incident in the panel normal line direction is scattered to generate a scattered component having a great intensity in a direction perpendicular, with respect to the panel normal line direction, to respective major axes of liquid crystal molecules.

Thus, placing the light source device as described above allows light incident on the display panel from the light source device to be more effectively scattered and thus to reach the observer.

The display system may preferably be arranged such that the light source device projects the light beam onto the display panel only in a case where a color display is carried out; and in a case where a monochrome display is carried out, the light source device projects no light beam, and a display is carried out in such a manner that the electric field is selectively applied to the display medium so as to selectively achieve the light scattering state and the light transmitting state.

The above arrangement (i) when a color display is carried out, makes it possible to carry out a display having excellent design, and (ii) when no color display is necessary, for example, when text is displayed, drives only the display panel to carry out a monochrome light scattering/light transmitting display and thus to turn off the output of the light source device. This allows a display to be carried out with low power consumption.

The display system may preferably be arranged such that the display system includes a plurality of the display panel; and the display panels are arranged in a depth direction as viewed from the observer.

The above arrangement makes it possible to carry out a three-dimensional display (expression) utilizing the depth.

Further, in the case where the display system includes a plurality of the display panel, and the display panels are arranged in a depth direction as viewed from the observer as described above, the display system may preferably be arranged such that the display panels are arranged such that a larger display panel is located at a position farther in the depth direction away from the observer.

The above arrangement can provide a more natural sense of depth.

The display system may preferably be arranged such that the display panel has a curved panel surface.

With the above arrangement, in the case where, for example, the panel surface is curved so as to have a convexity toward the observer, it is possible to improve expressive power with respect to observation at various angles. Further, in the case where the panel surface is curved so as to have a convexity toward the observer, it is possible to carry out a display that provides a great sense of presence.

The display system may preferably be arranged such that the display system includes a plurality of the light source device; the light source devices projects respective light beams having colors different from one another.

The above arrangement makes it possible to (i) carry out, on the display panel, a colorful display having different colors in respective areas irradiated by light beams projected by the individual light source devices, and also (ii) display a color different from the above colors with use of an overlap between the light beams projected by the individual light source devices.

The display system may preferably be arranged such that the light source device is provided with a filter having a gray scale that is continuously varied.

The above arrangement makes it possible to carry out a uniform display having even brightness.

An electronic device of the present invention, as described above, includes the display system of the present invention. The electronic device can be any of various electronic devices, for example: an electronic device, such as a mobile telephone, an electronic dictionary, and an electronic picture frame, which can be used as a portable terminal; digital signage; a theater system; a display for office use; and a videoconference system.

A portable terminal of the present invention, as described above, includes the display system of the present invention.

The portable terminal may preferably be arranged such that the display device and the light source device both included in the display system are provided as separate devices independent of each other.

The above arrangement, which includes the display device and the light source device as separate devices independent of each other, makes it possible to distribute the weight burden of the devices in the portable terminal. Further, the above arrangement, which can separate the light source device and the display panel of the display device from each other by a distance, makes it possible to cause the light source device to emit light with uniform brightness to the entire display area of the display panel without use of a complicated optical system.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### INDUSTRIAL APPLICABILITY

The display panel and display system of the present invention can each achieve a transparent state (see-through state) having high panel transmittance, and carry out a display in which a figure looks as if it has popped up in the air. The display panel and display system of the present invention can thus be suitably used for various electronic devices, for example: a portable terminal such as a mobile telephone and an electronic dictionary; an electronic picture frame; digital signage; a theater system; a display for office use, and a videoconference system.

### REFERENCE SIGNS LIST

1 display system
2 display device
3 projector (light source device)
4 light source device
5 ND filter
6 circuit board
10 PDLC panel (display panel)
11 pixel
12 transparent portion
13 scattering portion
14 anti-reflection film
16 display area
20 substrate (active matrix substrate, first substrate)
21 transparent substrate
22 TFT (switching element)
23 pixel electrode
24 source wire (wire)
25 gate wire (wire)
26 Cs wire (wire)
27 wire reflectance reducing layer (reflectance
reducing layer)
30 substrate (counter substrate, second substrate)
31 transparent substrate
32 black matrix (light blocking film)
33 counter electrode
40 PDLC layer (display medium layer)
41 liquid crystal droplet
42 alignment direction (direction in which liquid crystal droplets are arranged)
43 entrance direction (direction in which light projected by a light source device enters the display panel)
44 major axis (major axis of a liquid crystal molecule)
51 data receiving section
52 data reception control section
53 arithmetic operation control section
54 video image control section
55 storage section
56 operation section
57 position information obtaining section
58 sensor
59 sensor
61 display control circuit
62 panel display control circuit
63 light source display control circuit
64 feedback circuit
71 retro-reflective plate
72 sensor light source
80 electronic picture frame (electronic component)
90 mobile telephone (portable terminal, electronic component)
91 display section
92 display surface
93 back surface
94 device body
95 compact projector (light source device)
96 opening window
97 video image outputting section
98 projection lens
99 aspheric concave surface reflecting mirror
100 reflecting surface
101 operation key
110 headphone (device; portable terminal, electronic device)
111 loud speaker section (electronic component)

1. A display panel comprising:
a first substrate including a wire;
a second substrate provided so as to face the first substrate; and
a display medium provided between the first substrate and the second substrate, the display medium being switched between a light transmitting state and a light scattering state in correspondence with presence or absence of an electric field applied to the display medium,
the display panel including no colored layer,
the display panel selectively forming a light transmitting region and a light scattering region in response to control of the presence or absence of the electric field applied to the display medium,
at least one of a reflectance reducing layer for reducing direct reflection of external light by the wire, a light blocking layer covering the wire, and the display medium being placed in front of the wire as viewed from an observer.

2. The display panel according to claim 1,
wherein:
an anti-reflection film is provided on a surface of at least one of the first substrate and the second substrate.

3. A display panel comprising:
a first substrate including a wire;
a second substrate provided so as to face the first substrate; and
a display medium provided between the first substrate and the second substrate, the display medium being switched between a light transmitting state and a light scattering state in correspondence with presence or absence of an electric field applied to the display medium,
the display panel including no colored layer,
the display panel selectively forming a light transmitting region and a light scattering region in response to control of the presence or absence of the electric field applied to the display medium,
an anti-reflection film being provided on a surface of at least one of the first substrate and the second substrate.

4. The display panel according to claim 1, wherein:
the first substrate is an active matrix substrate including a plurality of wires and a plurality of switching elements both provided in a matrix and;
the display panel selectively forms the light transmitting region and the light scattering region in response to control, by use of the switching elements, of the presence or absence of the electric field applied to the display medium.

5. A display system comprising:
a display device including the display panel according to claim 1; and
a light source device for projecting a monochrome or multicolor light beam onto the display panel.

6. The display system according to claim 5,
wherein:
the light source device projects the light beam onto only the light scattering region formed by the display panel.

7. The display system according to claim 5,
wherein:
the light source device projects the light beam onto the display panel from a side on which a back surface of the display panel is present.

8. The display system according to claim 5,
wherein:
the light source device projects the light beam onto the display panel at an incidence angle that is not greater than 80 degrees at a maximum.

9. The display system according to claim 8,
wherein:
the incidence angle is not greater than a Brewster's angle at the maximum.

10. The display system according to claim 5,
wherein:
the display medium is polymer dispersed liquid crystal or polymer network liquid crystal each of which (i) includes a polymer and liquid crystal droplets independent of or continuous with one another and (ii) achieves the light transmitting state when the electric field is being applied to the display medium and achieves the light scattering state when no electric field is being applied to the display medium;
the first substrate and the second substrate have respective surfaces each facing the display medium which surface has been subjected to an alignment process, the liquid crystal droplets being arranged along a direction of the alignment process for the first substrate and the second substrate in parallel to a substrate surface; and
the light source device is placed so that in a case where the light source device projects the light beam onto the display panel in a form of a planar projection, the light beam projected by the light source device enters the display panel in a direction that is perpendicular to a direction in which the liquid crystal droplets are arranged.

11. The display system according to claim 5,
wherein:
the display medium is polymer dispersed liquid crystal or polymer network liquid crystal each of which (i) includes a polymer and liquid crystal droplets independent of or continuous with one another and (ii) achieves the light scattering state when the electric field is being applied to the display medium and achieves the light transmitting state when no electric field is being applied to the display medium;
the first substrate and the second substrate have respective surfaces each facing the display medium which surface has been subjected to an alignment process, the liquid crystal droplets including liquid crystal molecules having respective major axes arranged along a direction of the alignment process for the first substrate and the second substrate in parallel to a substrate surface; and
the light source device is placed so that in a case where the light source device projects the light beam onto the display panel in a form of a planar projection, the light beam projected by the light source device enters the display panel in a direction that is perpendicular to the respective major axes of the liquid crystal molecules.

12. The display system according to claim 5,
wherein:
the light source device projects the light beam onto the display panel only in a case where a color display is carried out; and
in a case where a monochrome display is carried out, the light source device projects no light beam, and a display is carried out in such a manner that the electric field is selectively applied to the display medium so as to selectively achieve the light scattering state and the light transmitting state.

13. The display system according to claim 5,
wherein:
the display system includes a plurality of the display panel; and
the display panels are arranged in a depth direction as viewed from the observer.

14. The display system according to claim 13,
wherein:
the display panels are arranged such that a larger display panel is located at a position farther in the depth direction away from the observer.

15. The display system according to claim 5,
wherein:
the display panel has a curved panel surface.

16. The display system according to claim 5,
wherein:
the display system includes a plurality of the light source device;
the light source devices projects respective light beams having colors different from one another.

17. The display system according to claim 5,
wherein:
the light source device is provided with a filter having a gray scale that is continuously varied.

18. A portable terminal comprising:
the display system according to claim 5.

19. The portable terminal according to claim 18,
wherein:
the display device and the light source device both included in the display system are provided as separate devices independent of each other.

20. An electronic device comprising:
the display system according to claim 5.

21. The display panel according to claim 3, wherein:
the first substrate is an active matrix substrate including a plurality of wires and a plurality of switching elements both provided in a matrix and;
the display panel selectively forms the light transmitting region and the light scattering region in response to control, by use of the switching elements, of the presence or absence of the electric field applied to the display medium.

22. A display system comprising:
a display device including the display panel according to claim 3; and
a light source device for projecting a monochrome or multicolor light beam onto the display panel.

23. The display system according to claim 22,
wherein:
the light source device projects the light beam onto only the light scattering region formed by the display panel.

24. The display system according to claim 22,
wherein:
the light source device projects the light beam onto the display panel from a side on which a back surface of the display panel is present.

25. The display system according to claim 22,
wherein:
the light source device projects the light beam onto the display panel at an incidence angle that is not greater than 80 degrees at a maximum.

26. The display system according to claim 25,
wherein:
the incidence angle is not greater than a Brewster's angle at the maximum.

27. The display system according to claim 22,
wherein:
the display medium is polymer dispersed liquid crystal or polymer network liquid crystal each of which (i) includes a polymer and liquid crystal droplets independent of or continuous with one another and (ii) achieves the light transmitting state when the electric field is being applied to the display medium and achieves the light scattering state when no electric field is being applied to the display medium;
the first substrate and the second substrate have respective surfaces each facing the display medium which surface has been subjected to an alignment process, the liquid crystal droplets being arranged along a direction of the alignment process for the first substrate and the second substrate in parallel to a substrate surface; and
the light source device is placed so that in a case where the light source device projects the light beam onto the display panel in a form of a planar projection, the light beam projected by the light source device enters the display panel in a direction that is perpendicular to a direction in which the liquid crystal droplets are arranged.

28. The display system according to claim 22,
wherein:
the display medium is polymer dispersed liquid crystal or polymer network liquid crystal each of which (i) includes a polymer and liquid crystal droplets independent of or continuous with one another and (ii) achieves the light scattering state when the electric field is being applied to the display medium and achieves the light transmitting state when no electric field is being applied to the display medium;
the first substrate and the second substrate have respective surfaces each facing the display medium which surface has been subjected to an alignment process, the liquid crystal droplets including liquid crystal molecules having respective major axes arranged along a direction of the alignment process for the first substrate and the second substrate in parallel to a substrate surface; and
the light source device is placed so that in a case where the light source device projects the light beam onto the display panel in a form of a planar projection, the light beam projected by the light source device enters the display panel in a direction that is perpendicular to the respective major axes of the liquid crystal molecules.

29. The display system according to claim 22,
wherein:
the light source device projects the light beam onto the display panel only in a case where a color display is carried out; and
in a case where a monochrome display is carried out, the light source device projects no light beam, and a display is carried out in such a manner that the electric field is selectively applied to the display medium so as to selectively achieve the light scattering state and the light transmitting state.

30. The display system according to claim 22,
wherein:
the display system includes a plurality of the display panel; and
the display panels are arranged in a depth direction as viewed from the observer.

31. The display system according to claim 30,
wherein:
the display panels are arranged such that a larger display panel is located at a position farther in the depth direction away from the observer.

32. The display system according to claim 22,
wherein:
the display panel has a curved panel surface.

33. The display system according to claim 22,
wherein:
the display system includes a plurality of the light source device;
the light source devices projects respective light beams having colors different from one another.

34. The display system according to claim 22,
wherein:
the light source device is provided with a filter having a gray scale that is continuously varied.

35. A portable terminal comprising:
the display system according to claim 3.

36. The portable terminal according to claim 35,
wherein:
the display device and the light source device both included in the display system are provided as separate devices independent of each other.

37. An electronic device comprising:
the display system according to claim 3.
